(19) United States
(12) Patent Application Publication
(10) Pub. No.: US 2025/0392049 A1
(43) Pub. Date: Dec. 25, 2025

(54) ANTENNA STRUCTURE AND ELECTRONIC DEVICE

(71) Applicants: Beijing BOE Technology Development Co., Ltd., Beijing (CN); BOE Technology Group Co., Ltd., Beijing (CN)

(72) Inventors: Yu LUO, Beijing (CN); Shiqiao ZHANG, Beijing (CN); Jia FANG, Beijing (CN); Cheng PAN, Beijing (CN); Biqi LI, Beijing (CN); Feng QU, Beijing (CN)

(21) Appl. No.: 18/993,002

(22) PCT Filed: Apr. 19, 2024
(86) PCT No.: PCT/CN2024/088876

§ 371 Date: Jan. 10, 2025

(30) Foreign Application Priority Data
May 22, 2023 (CN) 202310580228.1

(51) Int. Cl. H01Q 9/06; H01Q 9/42; H01Q 15/14

(52) U.S. Cl. CPC H01Q 9/065; H01Q 9/42; H01Q 15/14

(57) ABSTRACT

An antenna structure, at least comprising: a substrate (150); and a first element antenna arm (110), a second element antenna arm (120), a feed structure (140) and a resonance portion (130), which are arranged on the substrate, wherein the first element antenna arm (110) is in communication with the feed structure (140) by means of the resonance portion (130); the second element antenna arm (120) is in communication with the feed structure (140) by means of the resonance portion (130); the resonance portion (130) is in communication with the feed structure (140); the antenna structure has a symmetry axis (AA′); the first element antenna arm (110) and the second element antenna arm (120) are symmetrical about the symmetry axis (AA′); the resonance portion (130) is symmetrical about the symmetry axis (AA′).

### CROSS-REFERENCE TO RELATED APPLICATIONS

The present application is a U.S. National Phase Entry of International Application No. PCT/CN2024/088876 having an international filing date of Apr. 19, 2024, which claims priority of Chinese Patent Application No. 202310580228.1, filed to the CNIPA on May 22,2023 and entitled “Antenna Structure and Electronic Device”. The entire contents of the above-identified applications are incorporated herein by reference.

### TECHNICAL FIELD

The present disclosure relates to, but is not limited to, the field of wireless communication technologies, and in particular to an antenna structure and an electronic device.

### BACKGROUND

With the development of wireless communication technologies and electronic technologies, wireless communication devices with 433 MHZ have been more widely used in fields such as portable devices and vehicle-mounted terminals. However, due to low frequency and long wavelength of the wireless communication devices with 433 MHZ, the antenna size is generally large, which in turn affects the development of miniaturization of communication technology in this frequency band.

### SUMMARY

The following is a summary of subject matters described herein in detail. This summary is not intended to limit the protection scope of claims.

An embodiment of the present disclosure provides an antenna structure, which at least includes a substrate, and a first element antenna arm, a second element antenna arm, a feed structure and a resonant portion that are disposed on the substrate.

The first element antenna arm is communicated with the feed structure through the resonant portion, the second element antenna arm is communicated with the feed structure through the resonant portion, and the resonant portion is communicated with the feed structure.

The antenna structure has a symmetry axis. The first element antenna arm and the second element antenna arm are symmetrical about the symmetry axis. The resonant portion is symmetrical about the symmetry axis. A connection point at which the resonant portion and the feed structure are connected is located on the symmetry axis.

In some exemplary implementations, each one of the first element antenna arm and the second element antenna arm includes N first extension segments extending along a first direction and N−1 second extension segments extending along a second direction. The N first extension segments are sequentially arranged in the second direction, a first end of a first first extension segment is connected to the resonant portion, and a second end of an i-th first extension segment is connected to a first end of an (i+1)-th first extension segment through a second extension segment, where i is an integer greater than 0 and less than N, and N is an integer greater than 1. The first direction intersects with the second direction.

In some exemplary implementations, a length of a first extension segment is greater than a length of a second extension segment.

In some exemplary implementations, in each element antenna arm, lengths of a second first extension segment to an N-th first extension segment are the same, and a length of a first first extension segment is smaller than a length of the second first extension segment.

In some exemplary implementations, in each element antenna arm, a length of a (2j)-th first extension segment is the same as a length of a (2j+1)-th first extension segment, and a length of a (2×(j+1))-th first extension segment is greater than the length of the (2j+1)-th first extension segment, where j is an integer greater than 0.

In some exemplary implementations, in each element antenna arm, a length of a (2j)-th first extension segment is the same as a length of a (2j+1)-th first extension segment, and a length of a (2×(j+1))-th first extension segment is smaller than the length of the (2j+1)-th first extension segment, where j is an integer greater than 0.

In some exemplary implementations, in each element antenna arm, differences between the length of the (2×(j+1))-th first extension segment and the length of the (2j+1)-th first extension segment are the same.

In some exemplary implementations, in each element antenna arm, differences between the length of the (2×(j+1))-th first extension segment and the length of the (2j+1)-th first extension segment are not the same.

In some exemplary implementations, lengths of the N−1 second extension segments of each element antenna arm are the same.

In some exemplary implementations, the resonant portion includes a semicircular structure, and the semicircular structure includes a first arc-shaped edge and a linear edge.

A circle center of the semicircular structure is on the symmetry axis, and the feed structure is connected to the first arc-shaped edge. The semicircular structure has a groove at the linear edge.

The groove is symmetrical about the symmetry axis.

In some exemplary implementations, the resonant portion includes at least a semicircular ring structure. The semicircular ring structure includes a second arc-shaped edge and a third arc-shaped edge. The second arc-shaped edge is located on a side of the third arc-shaped edge away from the first element antenna arm and the second element antenna arm.

A circle center of the semicircular ring structure is on the symmetry axis. The feed structure is located between the second arc-shaped edge and the third arc-shaped edge.

In some exemplary implementations, the resonant portion further includes a short-circuit stub. The short-circuit stub is symmetrical about the symmetry axis.

The short-circuit stub includes one third extension segment extending along a first direction and two fourth extension segments extending along a second direction. The two fourth extension segments are connected by the third extension segment.

Each fourth extension segment is connected to the third arc-shaped edge. The first direction intersects with the second direction.

In some exemplary implementations, the resonant portion further includes an open-circuit stub. The open-circuit stub is symmetrical about the symmetry axis.

The open-circuit stub is connected to the second arc-shaped edge, and the open-circuit stub is located on a side of the short-circuit stub close to the second arc-shaped edge.

In some exemplary implementations, the open-circuit stub is located on the symmetry axis.

In some exemplary implementations, the feed structure includes a first ground plate, a second ground plate, and a microstrip line. The microstrip line is connected to the first arc-shaped edge. The first ground plate and the second ground plate are located on twos sides of the microstrip line.

In some exemplary implementations, the microstrip line is symmetrical about the symmetry axis and is located on the symmetry axis.

In some exemplary implementations, the feed structure includes a coaxial cable and a feed port. The coaxial cable is connected to the feed port.

In some exemplary implementations, an orthographic projection of the feed port on the substrate is rectangular.

In some exemplary implementations, the antenna structure further includes a reflective ground. The reflective ground is located on a side of the feed structure away from the resonant portion.

An embodiment of the present disclosure provides an electronic device, including the antenna structure as described above.

Other aspects of the present disclosure can be comprehended after the drawings and the detailed descriptions are read and understood.

### BRIEF DESCRIPTION OF DRAWINGS

Drawings are used for providing further understanding of technical solutions of the present disclosure, constitute a portion of the specification, and are used for explaining the technical solutions of the present disclosure together with embodiments of the present disclosure, but do not constitute limitations on the technical solutions of the present disclosure. Shapes and sizes of one or more components in the drawings do not reflect actual scales, but are only intended to schematically describe contents of the present disclosure.

FIG. 1A is a schematic plan view of an antenna structure according to at least one embodiment of the present disclosure.

FIG. 1B is a simulation result diagram of a curve S11 of the antenna structure as shown in FIG. 1A.

FIG. 1C is a schematic view of a three-dimensional radiation direction of the antenna structure as shown in FIG. 1A.

FIG. 2 is another schematic plan view of an antenna structure according to at least one embodiment of the present disclosure.

FIG. 3 is another schematic plan view of an antenna structure according to at least one embodiment of the present disclosure.

FIG. 4 is another schematic plan view of an antenna structure according to at least one embodiment of the present disclosure.

FIG. 5 is another schematic plan view of an antenna structure according to at least one embodiment of the present disclosure.

FIG. 6 is another schematic plan view of an antenna structure according to at least one embodiment of the present disclosure.

FIG. 7 is another schematic plan view of an antenna structure according to at least one embodiment of the present disclosure.

FIG. 8 is another schematic plan view of an antenna structure according to at least one embodiment of the present disclosure.

FIG. 9A is a schematic plan view of an antenna structure according to at least one embodiment of the present disclosure.

FIG. 9B is a simulation result diagram of a curve S11 of the antenna structure as shown in FIG. 9A.

FIG. 9C is a schematic view of a three-dimensional radiation direction of the antenna structure as shown in FIG. 9A.

FIG. 10 is another schematic plan view of an antenna structure according to at least one embodiment of the present disclosure.

FIG. 11 is another schematic plan view of an antenna structure according to at least one embodiment of the present disclosure.

FIG. 12 is another schematic plan view of an antenna structure according to at least one embodiment of the present disclosure.

FIG. 13 is a schematic diagram of an electronic device according to at least one embodiment of the present disclosure.

### DETAILED DESCRIPTION

The embodiments of the present disclosure will be described below with reference to the drawings in detail. Implementations may be implemented in multiple different forms. Those of ordinary skills in the art can easily understand such a fact that implementations and contents may be transformed into one or more forms without departing from the purpose and scope of the present disclosure. Therefore, the present disclosure should not be explained as being limited to the contents recorded in the following implementations only. The embodiments and features in the embodiments of the present disclosure may be randomly combined with each other if there is no conflict.

In the drawings, a size of one or more constituent elements, a thickness of a layer, or a region is sometimes exaggerated for clarity. Therefore, one implementation of the present disclosure is not necessarily limited to the dimensions, and shapes and sizes of a plurality of components in the drawings do not reflect actual scales. In addition, the drawings schematically illustrate ideal examples, and an implementation of the present disclosure is not limited to shapes, numerical values, or the like shown in the drawings.

Ordinal numerals such as “first”, “second” and “third” in the present disclosure are set to avoid confusion between constituent elements, but not intended for restriction in quantity. “A plurality of” in the present disclosure means two or more in quantity.

In the present disclosure, for convenience, wordings indicating orientation or positional relationship such as “middle”, “upper”, “lower”, “front”, “rear”, “vertical”, “horizontal”, “top”, “bottom”, “inner” and “outer” are employed to explain positional relationship between the constituent elements with reference to the drawings, they are employed for ease of description of the specification and simplification of the description only, but do not indicate or imply that the referred device or element must have a particular orientation, or is constructed and operated in a particular orientation, and therefore cannot be construed as limitations on the present disclosure. The positional relationships between the constituent elements are changed as appropriate based on directions according to which the constituent elements are described. Therefore, appropriate replacements based on situations are allowed, which is not limited to the expressions in the specification.

In the present disclosure, the terms “mounting”, “coupling” and “connection” are to be understood broadly, unless otherwise expressly specified and defined. For example, it may be a fixed connection, or a detachable connection, or an integral connection; it may be a mechanical connection or an electrical connection; it may be a direct connection, or an indirect connection through a middleware, or an internal communication between two elements. Those of ordinary skills in the art may understand meanings of the aforementioned terms in the present disclosure according to situations.

In the present disclosure, “electric connection” includes a case in which constituent elements are connected through an element with a certain electrical effect. The “element with a certain electrical effect” is not particularly limited as long as electrical signals between the connected constituent elements can be transmitted. Examples of the “element with a certain electrical effect” not only include electrodes and wirings, but also include switching elements such as transistors, resistors, inductors, capacitors, other elements with one or more functions, and the like.

In the present disclosure, “parallel” refers to a state in which an angle formed by two straight lines is above −10° and below 10°, and thus may include a state in which the angle is above −5° and below 5°. In addition, “perpendicular” refers to a state in which an angle formed by two straight lines is above 80° and below 100°, and thus may include a state in which the angle is above 85° and below 95°.

In the present disclosure, “about” means that a boundary is not defined so strictly and numerical values within process and measurement error ranges are allowed.

In the present disclosure, a Micro-strip (MS) refers to a microwave transmission line composed of a single conductor strip supported on a dielectric substrate.

An embodiment of the present disclosure provides an antenna structure, which at least includes a substrate, and a first element antenna arm, a second element antenna arm, a feed structure and a resonant portion that are disposed on the substrate. The first element antenna arm is communicated with the feed structure through the resonant portion, the second element antenna arm is communicated with the feed structure through the resonant portion, and the resonant portion is communicated with the feed structure. The antenna structure has a symmetry axis. The first element antenna arm and the second element antenna arm are symmetrical about the symmetry axis, the resonant portion is symmetrical about the symmetry axis, and a connection point at which the resonant portion and the feed structure are connected is located on the symmetry axis.

In the antenna structure provided by the present embodiment, energy distribution is adjusted by providing the first element antenna arm and the second element antenna arm that are symmetrical about the symmetry axis, and the resonant portion that is symmetrical about the symmetry axis, so that gathered energy is radiated along a gap between the first element antenna arm and the second element antenna arm, thereby improving gain. Moreover, the antenna structure provided by the present embodiment has a simple structure and a small echo loss.

In some exemplary implementations, each one of the first element antenna arm and the second element antenna arm may include N first extension segments extending along a first direction and N−1 second extension segments extending along a second direction. The N first extension segments are sequentially arranged in the second direction, a first end of a first first extension segment is connected to the resonant portion, and a second end of an i-th first extension segment is connected to a first end of an (i+1)-th first extension segment through a second extension segment, where i is an integer greater than 0 and less than N, and N is an integer greater than 1. The first direction intersects with the second direction. For example, the first direction may be perpendicular to the second direction. In the antenna structure of this example, an electrical length required for resonance of the antenna structure is achieved by using a symmetrical element structure with a folding form, which is beneficial to bandwidth expanding and miniaturization of the antenna structure. Moreover, current distribution of the antenna is changed such that the gathered energy is radiated along a gap between the first element antenna arm and the second element antenna arm, thereby improving gain.

In some exemplary implementations, N is an odd number. For example, a value of N may be 7. Since the current path will be reversed after passing through a quarter-wavelength, when the number of the first extension segments is an even number, the current will be reversed, resulting in a decrease in gain. Therefore, in this example, by setting the number of the first extension segments to an odd number, the decrease in gain caused by the reverse of current can be improved, and a radiation gain of the antenna structure can be increased to a certain extent.

In some exemplary implementations, N is an even number. For example, a value of N may be 8.

In some exemplary implementations, a length of a first extension segment is greater than a length of a second extension segment.

In some exemplary implementations, in each element antenna arm, lengths of a second first extension segment to an N-th first extension segment are the same, and a length of a first first extension segment is smaller than a length of the second first extension segment.

In some exemplary implementations, in each element antenna arm, a length of a (2j)-th first extension segment is the same as a length of a (2j+1)-th first extension segment, and a length of a (2×(j+1))-th first extension segment is greater than the length of the (2j+1)-th first extension segment, where j is an integer greater than 0.

For example, folded lengths of two arms of a dipole antenna gradually increase from the feed point to ends of folded elements. Through an increasing manner, coupling effect between two dipole arms can be reduced, and a distance between the two dipole arms can be extended in the antenna structure to reduce unnecessary coupling. Particularly, the energy is stronger at an end near the feed end, the coupling is greater if the two dipole arms are too close, while at an end far away from the feed end, the energy gradually weakens, and the coupling effect is slightly smaller even if the two arms are relatively close to each other.

In some exemplary implementations, in each element antenna arm, a length of a (2j)-th first extension segment is the same as a length of a (2j+1)-th first extension segment, and a length of a (2×(j+1))-th first extension segment is smaller than the length of the (2j+1)-th first extension segment, where j is an integer greater than 0.

For example, folded lengths of two arms of a dipole antenna gradually decrease from the feed point to ends of folded elements. The elements are folded in a decreasing manner, so that at an end near the feed end, current intensity is relatively strong, and if other integrated components are added, it will lead to strong electromagnetic coupling. At an end far away from the feed end, lengths of the folded elements are relatively small, the current intensity becomes weak, and when other integrated components are added, the electromagnetic coupling is relatively small, making it easier to integrate.

In some exemplary implementations, in each element antenna arm, differences between a length of a (2×(j+1))-th first extension segment and a length of a (2j+1)-th first extension segment are the same.

In some exemplary implementations, in each element antenna arm, differences between a length of a (2×(j+1))-th first extension segment and a length of a (2j+1)-th first extension segment are not the same.

In some exemplary implementations, lengths of the N−1 second extension segments of each element antenna arm are the same.

In some exemplary implementations, the resonant portion includes a semicircular structure, and the semicircular structure includes a first arc-shaped edge and a linear edge.

A circle center of the semicircular structure is on the symmetry axis, and the feed structure is connected to the first arc-shaped edge. The semicircular structure has a groove at the linear edge.

The groove is symmetrical about the symmetry axis.

The semicircular structure is used to introduce a multi-resonance mode. By folding element arms, currents in a vertical direction are superimposed and currents in a horizontal direction are cancelled out, and simultaneously, a gradual form is used to increase bandwidth.

In some exemplary implementations, the resonant portion includes at least a semicircular ring structure. The semicircular ring structure includes a second arc-shaped edge and a third arc-shaped edge. The second arc-shaped edge is located on a side of the third arc-shaped edge away from the first element antenna arm and the second element antenna arm.

A circle center of the semicircular ring structure is on the symmetry axis. The feed structure is located between the second arc-shaped edge and the third arc-shaped edge.

In some exemplary implementations, the resonant portion further includes a short-circuit stub. The short-circuit stub is symmetrical about the symmetry axis.

The short-circuit stub includes one third extension segment extending along a first direction and two fourth extension segments extending along a second direction. The two fourth extension segments are connected by the third extension segment.

Each fourth extension segment is connected to the third arc-shaped edge. The first direction intersects with the second direction.

A path that a current can flow through may be added at a semicircle through the short-circuit stub. A current may flow directly to an end of a folded structure through the semicircle and be radiated, or may flow through the short-circuit stub and then flow to the end of the folded structure. However, there is a certain phase difference between currents of the two different paths, and the currents may be superimposed in the folded structure, which may play a role in current enhancement. Therefore, a phase of the current may be adjusted by adjusting a size of the short-circuit stub and its distance from an end of the semicircle, thereby adjusting the gain of the whole structure.

The short-circuit stub also serves as a main matching structure to form a closed circulation current and gather energy. By adjusting folded lengths of element arms and spacing between elements, currents in a vertical direction are cancelled out, and the gathered energy is radiated along a gap between two elements, thus improving gain.

In some exemplary implementations, the resonant portion further includes an open-circuit stub. The open-circuit stub is symmetrical about the symmetry axis.

The open-circuit stub is connected to the second arc-shaped edge, and the open-circuit stub is located on a side of the short-circuit stub close to the second arc-shaped edge.

In some exemplary implementations, the open-circuit stub is located on the symmetry axis.

Matching of the feed end is adjusted by adjusting a length and width of the open-circuit stub.

In some exemplary implementations, the feed structure includes a first ground plate, a second ground plate, and a microstrip line. The microstrip line is connected to the first arc-shaped edge. The first ground plate and the second ground plate are located on twos sides of the microstrip line.

In some exemplary implementations, the microstrip line is symmetrical about the symmetry axis and is located on the symmetry axis.

By comprehensively utilizing the coupling effect of the microstrip line and the semicircular gradual structure with a groove, a good match is achieved, and the bandwidth can be further expanded in combination with a CPW feeding mode.

In some exemplary implementations, the feed structure includes a coaxial cable and a feed port. The coaxial cable is connected to the feed port.

In some exemplary implementations, an orthographic projection of the feed port on the substrate is rectangular.

In some exemplary implementations, the antenna structure further includes a reflective ground. The reflective ground is located on a side of the feed structure away from the resonant portion.

For example, a reflective ground GND is loaded at a distance of about one-quarter wavelength from the feed end of the folded dipole antenna. Since the reflective ground and the folded dipole antenna are spaced by one-quarter wavelength, radiation energy generated by the reflective ground and the dipole folded antenna in the far field is superimposed with each other and is enhanced, so that the gain of the antenna can be increased. For a dipole antenna, its radiation pattern is omnidirectional radiation. However, after the GND is added, the GND plays a reflective role, reflecting all the energy that should have been radiated to the GND side to the front of the antenna, so the radiation pattern presents end-fire radiation. Therefore, loading the GND can not only change the radiation pattern of the antenna but also increase the gain by about 3 dB.

The antenna structure of this embodiment is described below through multiple examples.

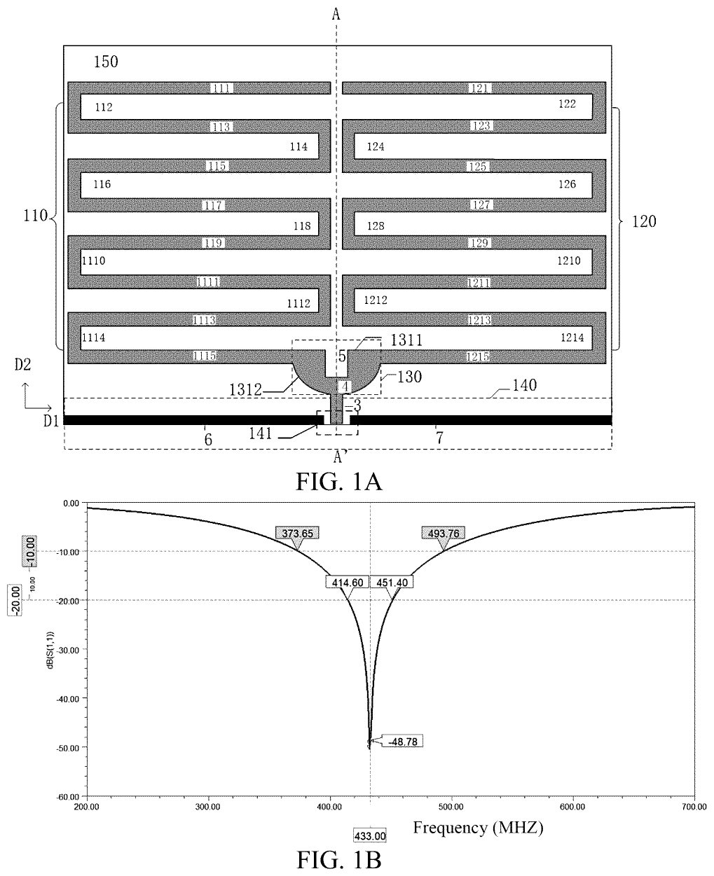

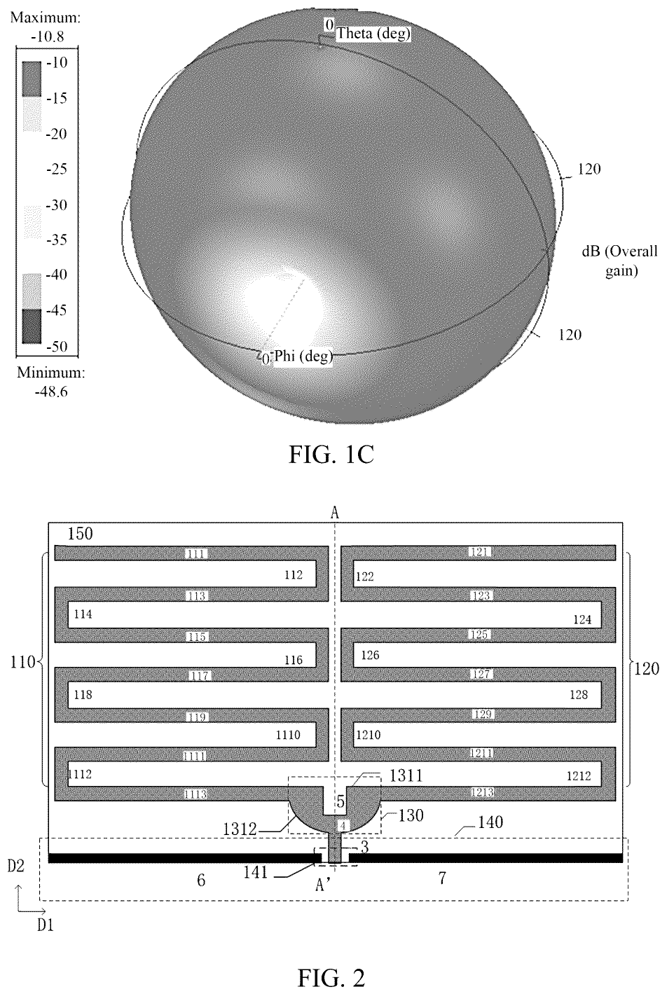

FIG. 1A is a schematic plan view of an antenna structure according to at least one embodiment of the present disclosure. The antenna structure presents a symmetrical structure about a symmetry axis, and the symmetry axis may be a central axis AA′ of a substrate. A first direction D1 and a second direction D2 in FIG. 1A are in a same plane, and the first direction D1 is perpendicular to the second direction D2.

In some exemplary implementations, as shown in FIG. 1A, the antenna structure of the present exemplary embodiment includes a substrate 150, and a first element antenna arm 110, a second element antenna arm 120, a resonant portion 130, and a feed structure 140 that are disposed on the substrate 150. The first element antenna arm 110 and the second element antenna arm 120 are connected to the resonant portion 130, respectively. The resonant portion 130 is connected to the feed structure 140.

In some examples, a substrate material of the substrate 150 may include, but is not limited to, a Rogers substrate, F4BM, FR4, a liquid crystal material, and the like.

In some examples, as shown in FIG. 1A, the resonant portion 130 may include a semicircular structure 4. The semicircular structure 4 may be symmetrical about the symmetry axis. The semicircular structure 4 may include a first arc-shaped edge 1312 and a linear edge 1311. The first arc-shaped edge 1312 may be located on a side of the linear edge 1311 away from the first element antenna arm 110 and the second element antenna arm 120. There is a groove 5 at the linear edge 1311. An orthographic projection of the groove 5 on the substrate 150 may be substantially rectangular, for example, may be rectangular. For example, a length of the orthographic projection of the groove 5 on the substrate 150 along the first direction D1 may be smaller than a length thereof along the second direction D2. An opening of the groove 5 is located on a side of the linear edge 1311 facing away from the feed structure 140. The groove 5 may be substantially symmetrical about the symmetry axis. The feed structure 140 may be connected to the first arc-shaped edge 1312. The feed structure 140 has a feed port 142, which, for example, may be located on the symmetry axis.

In some examples, as shown in FIG. 1A, the feed structure 140 may be symmetrical about the symmetry axis. The feed structure 140 may include a first ground plate 6, a second ground plate 7, and a microstrip line 3. The microstrip line 3 is connected to the feed structure 140, and the first ground plate 6 and the second ground plate 7 are located on two sides of the microstrip line 3. The microstrip line 3, the first ground plate 6 and the second ground plate 7 together form a Coplanar Waveguide (CPW) feed structure. In some examples, the first ground plate 6 and the second ground plate 7 may have same dimensions, for example, a length (such as a length along the first direction D1 in FIG. 1A) may be about 44.8 millimeters (mm) and a width (such as a length along the second direction D2 in FIG. 1A) may be about 3 mm.

In some examples, as shown in FIG. 1A, the first element antenna arm 110 and the second element antenna arm 120 may be symmetrical about the symmetry axis. The first element antenna arm 110 may include a plurality of first extension segments extending along the first direction D1 (e.g., including a first first extension segment 1115, a second first extension segment 1113, a third first extension segment 1111, a fourth first extension segment 119, a fifth first extension segment 117, a sixth first extension segment 115, a seventh first extension segment 113, and an eighth first extension segment 111), and a plurality of second extension segments extending along the second direction D2 (e.g., including a first second extension segment 1114, a second second extension segment 1112, a third second extension segment 1110, a fourth second extension segment 118, a fifth second extension segment 116, a sixth second extension segment 114, and a seventh second extension segment 112). In this example, the number of first extension segments of the first element antenna arm 110 extending along the first direction is an even number (e.g., eight), and the number of second extension segments extending along the second direction is an odd number (e.g., seven).

In some examples, a first end of the first first extension segment 1115 is connected to the resonant portion 130, and a second end of the first first extension segment 1115 is connected to a first end of the second first extension segment 1113 through the first second extension segment 1114. A second end of the second first extension segment 1113 is connected to a first end of the third first extension segment 1111 through the second second extension segment 1112. A second end of the third first extension segment 1111 is connected to a first end of the fourth first extension segment 119 through the third second extension segment 1110. A second end of the fourth first extension segment 119 is connected to a first end of the fifth first extension segment 117 through the fourth second extension segment 118. A second end of the fifth first extension segment 117 is connected to a first end of the sixth first extension segment 115 through the fifth second extension segment 116. A second end of the sixth first extension segment 115 is connected to a first end of the seventh first extension segment 113 through the sixth second extension segment 114. A second end of the seventh first extension segment 113 is connected to a first end of the eighth first extension segment 111 through the seventh second extension segment 112. A second end of the eighth first extension segment 111 serves as an end of the first element antenna arm 110.

In some examples, the second element antenna arm 120 may include a plurality of first extension segments extending along the first direction D1 (e.g., including a first first extension segment 1215, a second first extension segment 1213, a third first extension segment 1211, a fourth first extension segment 129, a fifth first extension segment 127, a sixth first extension segment 125, a seventh first extension segment 123, and an eighth first extension segment 121), and a plurality of second extension segments extending along the second direction D2 (e.g., including a first second extension segment 1214, a second second extension segment 1212, a third second extension segment 1210, a fourth second extension segment 128, a fifth second extension segment 126, a sixth second extension segment 124, and a seventh second extension segment 122). In this example, the number of first extension segments of the second element antenna arm 120 extending along the first direction is an even number (e.g., eight), and the number of second extension segments extending along the second direction is an odd number (e.g., seven).

In some examples, a first end of the first first extension segment 1215 is connected to the resonant portion 130, and a second end of the first first extension segment 1215 is connected to a first end of the second first extension segment 1213 through the first second extension segment 1214. A second end of the second first extension segment 1213 is connected to a first end of the third first extension segment 1211 through the second second extension segment 1212. A second end of the third first extension segment 1211 is connected to a first end of the fourth first extension segment 129 through the third second extension segment 1210. A second end of the fourth first extension segment 129 is connected to a first end of the fifth first extension segment 127 through the fourth second extension segment 128. A second end of the fifth first extension segment 127 is connected to a first end of the sixth first extension segment 125 through the fifth second extension segment 126. A second end of the sixth first extension segment 125 is connected to a first end of the seventh first extension segment 123 through the sixth second extension segment 124. A second end of the seventh first extension segment 123 is connected to a first end of the eighth first extension segment 121 through the seventh second extension segment 122. A second end of the eighth first extension segment 121 serves as an end of the second element antenna arm 120.

In some examples, widths of each first extension segment and each second extension segment may be substantially the same, such as may be 2 mm. Lengths of the second first extension segment 1113, the third first extension segment 1111, the fourth first extension segment 119, the fifth first extension segment 117, the sixth first extension segment 115, the seventh first extension segment 113, and the eighth first extension segment 111 may be substantially the same.

In some examples, the eighth first extension segment 111 and the seventh first extension segment 113 may be substantially symmetrical about a midline of the seventh second extension segment 112 in the second direction D2 (e.g., the midline is parallel to the first direction D1). The seventh first extension segment 113 and the sixth first extension segment 115 may be substantially symmetrical about a midline of the sixth second extension segment 114 in the second direction D2 (e.g., the midline is parallel to the first direction D1). And so on.

In some examples, taking the first element antenna arm 110 as an example, a folding process may be as follows. A straight element antenna arm may be bent at a right angle for a first time to form the first first extension segment 1115, may be bent at a right angle for a second time to form the first second extension segment 1114, may be bent at a right angle for a third time to form the second first extension segment 1113, may be bent at a right angle for a fourth time to form the second second extension segment 1112, . . . , may be bent at a right angle for a thirteenth time to form the seventh second extension segment 112, and may be bent at a right angle for a fourteenth time to form the eighth first extension segment 111.

In this example, the first element antenna arm 110, the second element antenna arm 120, and the semicircular structure 4 with the groove 5 may be used as a radiator. The radiator is used to make the antenna structure resonate in a 433 MHZ frequency band, and is used for impedance matching and performance optimization. An electrical length required for antenna resonance is achieved by a folded symmetrical element structure in a square wave shape, which is conducive to bandwidth expansion and miniaturization applications. The semicircular structure 4 with the groove 5 introduces a multi-resonance mode. By folding element arms, currents in a vertical direction are superimposed and currents in a horizontal direction are cancelled out, and simultaneously, a gradual form is used to increase bandwidth. The microstrip line 3 is coupled to the semicircular structure 4 with the groove 5 to achieve a good match, and the bandwidth is further expanded in combination with a CPW feeding mode.

In the present embodiment, each element antenna arm is bent at a right angle for fourteen times to form a folded structure in a square wave shape. A physical size of the antenna is effectively reduced by folding dipole elements multiple times. An overall size is 95 mm×58 mm×0.8 mm, and an actual size at a center operating frequency does not exceed a size of a spherical antenna with r=λ/2π, which meets size standards for electrical small antennas.

The radiator and the feed point works together, so that an effective operating frequency band of the embodiment of the present disclosure is 373.65 MHz-493.76 MHz, a bandwidth is 120.11 MHz, and a bandwidth ratio is 27.7%, as shown in FIGS. 1B and 1C, which significantly exceeds bandwidth performance of related technologies. Moreover, at the operating frequency band, a maximum echo loss of −10.8 dB is achieved, and at a center frequency point of 433 MHz, an echo loss of −48.78 dB is achieved, and one or more performance indicators are good.

FIG. 2 is a schematic plan view of an antenna structure according to at least one embodiment of the present disclosure. The antenna structure presents a symmetrical structure about a symmetry axis, and the symmetry axis may be a central axis AA′ of a substrate. A first direction D1 and a second direction D2 in FIG. 2 are in a same plane, and the first direction D1 is perpendicular to the second direction D2.

In some exemplary implementations, as shown in FIG. 2, the antenna structure of the present exemplary embodiment includes a substrate 150, and a first element antenna arm 110, a second element antenna arm 120, a resonant portion 130, and a feed structure 140 that are disposed on the substrate 150. The first element antenna arm 110 and the second element antenna arm 120 are connected to the resonant portion 130, respectively. The resonant portion 130 is connected to the feed structure 140.

In some examples, a substrate material of the substrate 150 may include, but is not limited to, a Rogers substrate, F4BM, FR4, a liquid crystal material, and the like.

In some examples, as shown in FIG. 2, the resonant portion 130 may include a semicircular structure 4. The semicircular structure 4 may be symmetrical about the symmetry axis. The semicircular structure 4 may include a first arc-shaped edge 1312 and a linear edge 1311. The first arc-shaped edge 1312 may be located on a side of the linear edge 1311 away from the first element antenna arm 110 and the second element antenna arm 120. There is a groove 5 at the linear edge 1311. An orthographic projection of the groove 5 on the substrate 150 may be substantially rectangular, for example, may be rectangular. For example, a length of the orthographic projection of the groove 5 on the substrate 150 along the first direction D1 may be smaller than a length thereof along the second direction D2. An opening of the groove 5 is located on a side of the linear edge 1311 facing away from the feed structure 140. The groove 5 may be substantially symmetrical about the symmetry axis. The feed structure 140 may be connected to the first arc-shaped edge 1312. The feed structure 140 has a feed port 142, for example, the feed port 142 may be located on the symmetry axis.

In some examples, as shown in FIG. 2, the antenna structure may further include the feed structure 140. The feed structure 140 may be symmetrical about the symmetry axis. The feed structure 140 may include a first ground plate 6, a second ground plate 7, and a microstrip line 3. The microstrip line 3 is connected to the first arc-shaped edge 1312, and the first ground plate 6 and the second ground plate 7 are located on two sides of the microstrip line 3. The microstrip line 3, the first ground plate 6 and the second ground plate 7 together form a Coplanar Waveguide (CPW) feed structure. In some examples, the first ground plate 6 and the second ground plate 7 may have same dimensions, for example, a length (such as a length along the first direction D1 in FIG. 1A) may be about 44.8 millimeters (mm) and a width (such as a length along the second direction D2 in FIG. 1A) may be about 3 mm.

In some examples, as shown in FIG. 2, the first element antenna arm 110 and the second element antenna arm 120 may be symmetrical about the symmetry axis. The first element antenna arm 110 may include a plurality of first extension segments extending along the first direction D1 (e.g., including a first first extension segment 1113, a second first extension segment 1111, a third first extension segment 119, a fourth first extension segment 117, a fifth first extension segment 115, a sixth first extension segment 113, and a seventh first extension segment 111), and a plurality of second extension segments extending along the second direction D2 (e.g., including a first second extension segment 1112, a second second extension segment 1110, a third second extension segment 118, a fourth second extension segment 116, a fifth second extension segment 114, and a sixth second extension segment 112). In this example, the number of first extension segments of the first element antenna arm 110 extending along the first direction is an odd number (for example, seven), and the number of second extension segments extending along the second direction is an even number (for example, eight).

In some examples, a first end of the first first extension segment 1113 is connected to the resonant portion 130, and a second end of the first first extension segment 1113 is connected to a first end of the second first extension segment 1111 through the first second extension segment 1112. A second end of the second first extension segment 1111 is connected to a first end of the third first extension segment 119 through the second second extension segment 1110. A second end of the third first extension segment 119 is connected to a first end of the fourth first extension segment 117 through the third second extension segment 118. A second end of the fourth first extension segment 117 is connected to a first end of the fifth first extension segment 115 through the fourth second extension segment 116. A second end of the fifth first extension segment 115 is connected to a first end of the sixth first extension segment 113 through the fifth second extension segment 114. A second end of the sixth first extension segment 113 is connected to a first end of the seventh first extension segment 111 through the sixth second extension segment 112. A second end of the seventh first extension segment 111 serves as an end of the first element antenna arm 110.

In some examples, the second element antenna arm 120 may include a plurality of first extension segments extending along the first direction D1 (e.g., including a first first extension segment 1213, a second first extension segment 1211, a third first extension segment 129, a fourth first extension segment 127, a fifth first extension segment 125, a sixth first extension segment 123, and a seventh first extension segment 121), and a plurality of second extension segments extending along the second direction D2 (e.g., including a first second extension segment 1212, a second second extension segment 1210, a third second extension segment 128, a fourth second extension segment 126, a fifth second extension segment 124, and a sixth second extension segment 122). In this example, the number of first extension segments of the second element antenna arm 120 extending along the first direction is an odd number (for example, seven), and the number of second extension segments extending along the second direction is an even number (for example, six).

In some examples, a first end of the first first extension segment 1213 is connected to the resonant portion 130, and a second end of the first first extension segment 1213 is connected to a first end of the second first extension segment 1211 through the first second extension segment 1212. A second end of the second first extension segment 1211 is connected to a first end of the third first extension segment 129 through the second second extension segment 1210. A second end of the third first extension segment 129 is connected to a first end of the fourth first extension segment 127 through the third second extension segment 128. A second end of the fourth first extension segment 127 is connected to a first end of the fifth first extension segment 125 through the fourth second extension segment 126. A second end of the fifth first extension segment 125 is connected to a first end of the sixth first extension segment 123 through the fifth second extension segment 124. A second end of the sixth first extension segment 123 is connected to a first end of the seventh first extension segment 121 through the sixth second extension segment 122. A second end of the seventh first extension segment 121 serves as an end of the second element antenna arm 120.

In some examples, widths of each first extension segment and each second extension segment may be substantially the same, such as may be 2 mm. Lengths of the second first extension segment 1111, the third first extension segment 119, the fourth first extension segment 117, the fifth first extension segment 115, the sixth first extension segment 113, and the seventh first extension segment 111 may be substantially the same.

In some examples, the seventh first extension segment 111 and the sixth first extension segment 113 may be substantially symmetrical about a midline of the sixth second extension segment 112 in the second direction D2 (e.g., the midline is parallel to the first direction D1). The sixth first extension segment 113 and the fifth first extension segment 115 may be substantially symmetrical about a midline of the fifth second extension segment 114 in the second direction D2 (e.g., the midline is parallel to the first direction D1). And so on.

In some examples, taking the first element antenna arm 110 as an example, a folding process may be as follows. A straight element antenna arm may be bent at a right angle for a first time to form the first first extension segment 1113, may be bent at a right angle for a second time to form the first second extension segment 1112, may be bent at a right angle for a third time to form the second first extension segment 1111, may be bent at a right angle for a fourth time to form the second second extension segment 1110, . . . , may be bent at a right angle for an eleventh time to form the sixth second extension segment 112, and may be bent at a right angle for a twelfth time to form the seventh first extension segment 111.

In this example, the first element antenna arm 110, the second element antenna arm 120, and the semicircular structure 4 with the groove 5 may be used as a radiator. The radiator is used to make the antenna resonate in a 433 MHZ frequency band, and is used for impedance matching and performance optimization. An electrical length required for antenna resonance is achieved by a folded symmetrical element structure in a square wave shape, which is conducive to bandwidth expansion and miniaturization applications. The semicircular structure 4 with the groove 5 introduces a multi-resonance mode. By folding element arms, currents in a vertical direction are superimposed and currents in a horizontal direction are cancelled out, and simultaneously, a gradual form is used to increase bandwidth. The microstrip line 3 is coupled to the semicircular structure 4 with the groove 5 to achieve a good match, and the bandwidth is further expanded in combination with a CPW feeding mode.

In this embodiment, each element antenna arm is bent at a right angle for twelve times to form a folded structure in a square wave shape, and a physical size of the antenna is effectively reduced by folding dipole elements multiple times. Compared with the antenna structure shown in FIG. 1A, the number of extension segments extending along the first direction is set to an odd number, so that the radiation gain of the antenna can be increased to a certain extent. When the entire antenna structure has an even number of folds, the current path will be reversed after passing through a quarter-wavelength. Therefore, after a folding element which has a length of an even number of quarter-wavelengths is bent, the current flowing through the folded element will be reversed and cancelled out in the far field, so that the gain is relatively low. When the number of extension segments extending along the first direction is set to an odd number, a complete cancellation will not occur, and the gain will be improved to a certain extent.

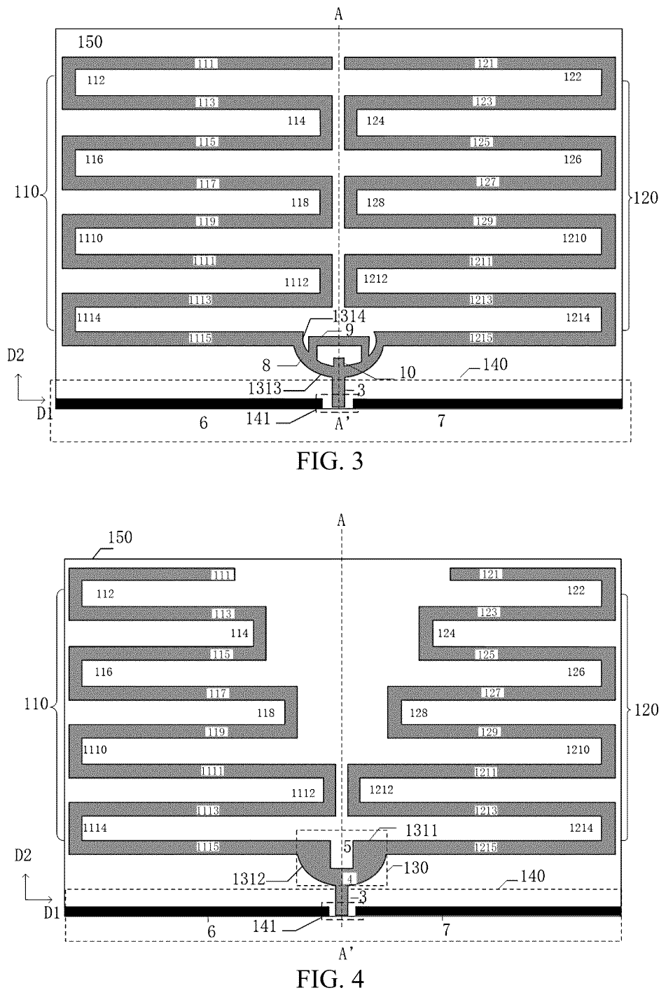

FIG. 3 is a schematic plan view of an antenna structure according to at least one embodiment of the present disclosure. The antenna structure presents a symmetrical structure about a symmetry axis, and the symmetry axis may be a central axis AA′ of a substrate. A first direction D1 and a second direction D2 in FIG. 3 are in a same plane, and the first direction D1 is perpendicular to the second direction D2.

In some exemplary implementations, as shown in FIG. 3, the antenna structure of the present exemplary embodiment includes a substrate 150, and a first element antenna arm 110, a second element antenna arm 120, a resonant portion 130, and a feed structure 140 that are disposed on the substrate 150. The first element antenna arm 110 and the second element antenna arm 120 are connected to the resonant portion 130, respectively. The resonant portion 130 is connected to the feed structure 140.

In some examples, a substrate material of the substrate 150 may include, but is not limited to, a Rogers substrate, F4BM, FR4, a liquid crystal material, and the like.

In some examples, as shown in FIG. 3, the resonant portion 130 may include a semicircular ring structure 8. The semicircular ring structure 8 may be symmetrical about the symmetry axis. The semicircular ring structure 8 includes a second arc-shaped edge 1313 and a third arc-shaped edge 1314, and a length of the second arc-shaped edge 1313 is greater than a length of the third arc-shaped edge 1314. The feed structure 140 may be located at the second arc-shaped edge 1313. For example, the feed structure 140 may be located on the symmetry axis.

In some examples, as shown in FIG. 3, the resonant portion 130 may further include a short-circuit stub 9, which is symmetrical about the symmetry axis. The short-circuit stub 9 is bridged on the semicircular ring structure 8. The short-circuit stub 9 is connected to the third arc-shaped edge 1314. The short-circuit stub 9 includes one third extension segment extending along a first direction and two fourth extension segments extending along a second direction. The two fourth extension segments are connected by the third extension segment. Each fourth extension segment is connected to the third arc-shaped edge 1314. The first direction intersects with the second direction. For example, the first direction is perpendicular to the second direction.

In some examples, as shown in FIG. 3, the resonant portion 130 may further include an open-circuit stub 10, which is symmetrical about the symmetry axis. The open-circuit stub 10 is connected to the second arc-shaped edge 1313 and the open-circuit stub 10 is located on a side of the short-circuit stub 9 close to the second arc-shaped edge 1313.

In some examples, as shown in FIG. 3, the feed structure 140 may be symmetrical about the symmetry axis. The feed structure 140 may include a first ground plate 6, a second ground plate 7, and a microstrip line 3. The microstrip line 3 is connected to the feed structure 140, and the first ground plate 6 and the second ground plate 7 are located on two sides of the microstrip line 3. The microstrip line 3, the first ground plate 6 and the second ground plate 7 together form a Coplanar Waveguide (CPW) feed structure. In some examples, the first ground plate 6 and the second ground plate 7 may have same dimensions, for example, a length (such as a length along the first direction D1 in FIG. 1A) may be about 44.8 millimeters (mm) and a width (such as a length along the second direction D2 in FIG. 1A) may be about 3 mm. The feed structure 140 has a feed port 142.

In some examples, as shown in FIG. 1A, the first element antenna arm 110 and the second element antenna arm 120 may be symmetrical about the symmetry axis. The first element antenna arm 110 may include a plurality of first extension segments extending along the first direction D1 (e.g., including a first first extension segment 1115, a second first extension segment 1113, a third first extension segment 1111, a fourth first extension segment 119, a fifth first extension segment 117, a sixth first extension segment 115, a seventh first extension segment 113, and an eighth first extension segment 111), and a plurality of second extension segments extending along the second direction D2 (e.g., including a first second extension segment 1114, a second second extension segment 1112, a third second extension segment 1110, a fourth second extension segment 118, a fifth second extension segment 116, a sixth second extension segment 114, and a seventh second extension segment 112). In this example, the number of first extension segments of the first element antenna arm 110 extending along the first direction is an even number (e.g., eight), and the number of second extension segments extending along the second direction is an odd number (e.g., seven).

In some examples, a first end of the first first extension segment 1115 is connected to the resonant portion 130, and a second end of the first first extension segment 1115 is connected to a first end of the second first extension segment 1113 through the first second extension segment 1114. A second end of the second first extension segment 1113 is connected to a first end of the third first extension segment 1111 through the second second extension segment 1112. A second end of the third first extension segment 1111 is connected to a first end of the fourth first extension segment 119 through the third second extension segment 1110. A second end of the fourth first extension segment 119 is connected to a first end of the fifth first extension segment 117 through the fourth second extension segment 118. A second end of the fifth first extension segment 117 is connected to a first end of the sixth first extension segment 115 through the fifth second extension segment 116. A second end of the sixth first extension segment 115 is connected to a first end of the seventh first extension segment 113 through the sixth second extension segment 114. A second end of the seventh first extension segment 113 is connected to a first end of the eighth first extension segment 111 through the seventh second extension segment 112. A second end of the eighth first extension segment 111 serves as an end of the first element antenna arm 110.

In some examples, the second element antenna arm 120 may include a plurality of first extension segments extending along the first direction D1 (e.g., including a first first extension segment 1215, a second first extension segment 1213, a third first extension segment 1211, a fourth first extension segment 129, a fifth first extension segment 127, a sixth first extension segment 125, a seventh first extension segment 123, and an eighth first extension segment 121), and a plurality of second extension segments extending along the second direction D2 (e.g., including a first second extension segment 1214, a second second extension segment 1212, a third second extension segment 1210, a fourth second extension segment 128, a fifth second extension segment 126, a sixth second extension segment 124, and a seventh second extension segment 122). In this example, the number of first extension segments of the second element antenna arm 120 extending along the first direction is an even number (e.g., eight), and the number of second extension segments extending along the second direction is an odd number (e.g., seven).

In some examples, a first end of the first first extension segment 1215 is connected to the resonant portion 130, and a second end of the first first extension segment 1215 is connected to a first end of the second first extension segment 1213 through the first second extension segment 1214. A second end of the second first extension segment 1213 is connected to a first end of the third first extension segment 1211 through the second second extension segment 1212. A second end of the third first extension segment 1211 is connected to a first end of the fourth first extension segment 129 through the third second extension segment 1210. A second end of the fourth first extension segment 129 is connected to a first end of the fifth first extension segment 127 through the fourth second extension segment 128. A second end of the fifth first extension segment 127 is connected to a first end of the sixth first extension segment 125 through the fifth second extension segment 126. A second end of the sixth first extension segment 125 is connected to a first end of the seventh first extension segment 123 through the sixth second extension segment 124. A second end of the seventh first extension segment 123 is connected to a first end of the eighth first extension segment 121 through the seventh second extension segment 122. A second end of the eighth first extension segment 121 serves as an end of the second element antenna arm 120.

In some examples, widths of each first extension segment and each second extension segment may be substantially the same, such as may be 2 mm. Lengths of the second first extension segment 1113, the third first extension segment 1111, the fourth first extension segment 119, the fifth first extension segment 117, the sixth first extension segment 115, the seventh first extension segment 113, and the eighth first extension segment 111 may be substantially the same.

In some examples, the eighth first extension segment 111 and the seventh first extension segment 113 may be substantially symmetrical about a midline of the seventh second extension segment 112 in the second direction D2 (e.g., the midline is parallel to the first direction D1). The seventh first extension segment 113 and the sixth first extension segment 115 may be substantially symmetrical about a midline of the sixth second extension segment 114 in the second direction D2 (e.g., the midline is parallel to the first direction D1). And so on.

In some examples, taking the first element antenna arm 110 as an example, a folding process may be as follows. A straight element antenna arm may be bent at a right angle for a first time to form the first first extension segment 1115, may be bent at a right angle for a second time to form the first second extension segment 1114, may be bent at a right angle for a third time to form the second first extension segment 1113, may be bent at a right angle for a fourth time to form the second second extension segment 1112, . . . , may be bent at a right angle for an thirteenth time to form the seventh second extension segment 112, and may be bent at a right angle for a fourteenth time to form the eighth first extension segment 111.

In this example, the first element antenna arm 110, the second element antenna arm 120, and the semicircular ring structure 8 may be used as a radiator. The radiator is used to make the antenna resonate in a 433 MHZ frequency band, and is used for impedance matching and performance optimization. An electrical length required for antenna resonance is achieved by a folded symmetrical element structure in a square wave shape, which is conducive to bandwidth expansion and miniaturization applications. The microstrip line 3 is coupled to the semicircular ring structure 8 to achieve a good match, and the bandwidth is further expanded in combination with a CPW feeding mode.

Compared with the structure described in FIG. 1A, an open-circuit stub and a short-circuit stub are added at the semicircular structure (e.g., the second arc-shaped edge 1313) of the feed end, and matching of the feed end can be adjusted by a length and width of the added open-circuit stub. The added short-circuit stub adds a path that a current may flow through at a semicircle (e.g., the second arc-shaped edge 1313). A current may flow directly to an end of a folded structure through the semicircular ring and be radiated, or may flow through the short-circuit stub and then flow to the end of the folded structure. However, there is a certain phase difference between currents of the two different paths, and the currents may be superimposed in the folded structure, which may play a role in current enhancement. Therefore, a phase of the current can be adjusted by adjusting a size of the short-circuit stub and its distance from the semicircular end (wherein the distance refers to a distance between the short-circuit stub 9 and a point of the second arc-shaped edge into which power is fed), and thus gain of the entire structure can be adjusted.

FIG. 4 is a schematic plan view of an antenna structure according to at least one embodiment of the present disclosure. The antenna structure presents a symmetrical structure about a symmetry axis, and the symmetry axis may be a central axis AA′ of a substrate. A first direction D1 and a second direction D2 in FIG. 4 are in a same plane, and the first direction D1 is perpendicular to the second direction D2.

In some exemplary implementations, as shown in FIG. 4, the antenna structure of the present exemplary embodiment includes a substrate 150, and a first element antenna arm 110, a second element antenna arm 120, a resonant portion 130, and a feed structure 140 that are disposed on the substrate 150. The first element antenna arm 110 and the second element antenna arm 120 are connected to the resonant portion 130, respectively. The resonant portion 130 is connected to the feed structure 140.

In some examples, a substrate material of the substrate 150 may include, but is not limited to, a Rogers substrate, F4BM, FR4, a liquid crystal material, and the like.

In some examples, as shown in FIG. 4, the resonant portion 130 may include a semicircular structure 4. The semicircular structure 4 may be symmetrical about the symmetry axis. The semicircular structure 4 may include a first arc-shaped edge 1312 and a linear edge 1311. The first arc-shaped edge 1312 may be located on a side of the linear edge 1311 away from the first element antenna arm 110 and the second element antenna arm 120. There is a groove 5 at the linear edge 1311. An orthographic projection of the groove 5 on the substrate 150 may be substantially rectangular, for example, may be rectangular. For example, a length of the orthographic projection of the groove 5 on the substrate 150 along the first direction D1 may be smaller than a length thereof along the second direction D2. An opening of the groove 5 is located on a side of the linear edge 1311 facing away from the feed structure 140. The groove 5 may be substantially symmetrical about the symmetry axis. The feed structure 140 may be connected to the first arc-shaped edge 1312. The feed structure has a feed port 142.

In some examples, as shown in FIG. 4, the antenna structure may further include the feed structure 140. The feed structure 140 may be symmetrical about the symmetry axis. The feed structure 140 may include a first ground plate 6, a second ground plate 7, and a microstrip line 3. The microstrip line 3 is connected to the first arc-shaped edge 1312, and the first ground plate 6 and the second ground plate 7 are located on two sides of the microstrip line 3. The microstrip line 3, the first ground plate 6 and the second ground plate 7 together form a CPW (Coplanar Waveguide) feed structure. In some examples, the first ground plate 6 and the second ground plate 7 may have same dimensions, for example, a length (such as a length along the first direction D1 in FIG. 1A) may be about 44.8 millimeters (mm) and a width (such as a length along the second direction D2 in FIG. 1A) may be about 3 mm.

In some examples, as shown in FIG. 4, the first element antenna arm 110 and the second element antenna arm 120 may be symmetrical about the symmetry axis. The first element antenna arm 110 may include a plurality of first extension segments extending along the first direction D1 (e.g., including a first first extension segment 1115, a second first extension segment 1113, a third first extension segment 1111, a fourth first extension segment 119, a fifth first extension segment 117, a sixth first extension segment 115, a seventh first extension segment 113, and an eighth first extension segment 111), and a plurality of second extension segments extending along the second direction D2 (e.g., including a first second extension segment 1114, a second second extension segment 1112, a third second extension segment 1110, a fourth second extension segment 118, a fifth second extension segment 116, a sixth second extension segment 114, and a seventh second extension segment 112). In this example, the number of first extension segments of the first element antenna arm 110 extending along the first direction is an even number (e.g., eight), and the number of second extension segments extending along the second direction is an odd number (e.g., seven).

In some examples, a first end of the first first extension segment 1115 is connected to the resonant portion 130, and a second end of the first first extension segment 1115 is connected to a first end of the second first extension segment 1113 through the first second extension segment 1114. A second end of the second first extension segment 1113 is connected to a first end of the third first extension segment 1111 through the second second extension segment 1112. A second end of the third first extension segment 1111 is connected to a first end of the fourth first extension segment 119 through the third second extension segment 1110. A second end of the fourth first extension segment 119 is connected to a first end of the fifth first extension segment 117 through the fourth second extension segment 118. A second end of the fifth first extension segment 117 is connected to a first end of the sixth first extension segment 115 through the fifth second extension segment 116. A second end of the sixth first extension segment 115 is connected to a first end of the seventh first extension segment 113 through the sixth second extension segment 114. A second end of the seventh first extension segment 113 is connected to a first end of the eighth first extension segment 111 through the seventh second extension segment 112. A second end of the eighth first extension segment 111 serves as an end of the first element antenna arm 110.

In some examples, the second element antenna arm 120 may include a plurality of first extension segments extending along the first direction D1 (e.g., including a first first extension segment 1215, a second first extension segment 1213, a third first extension segment 1211, a fourth first extension segment 129, a fifth first extension segment 127, a sixth first extension segment 125, a seventh first extension segment 123, and an eighth first extension segment 121), and a plurality of second extension segments extending along the second direction D2 (e.g., including a first second extension segment 1214, a second second extension segment 1212, a third second extension segment 1210, a fourth second extension segment 128, a fifth second extension segment 126, a sixth second extension segment 124, and a seventh second extension segment 122). In this example, the number of first extension segments of the second element antenna arm 120 extending along the first direction is an even number (e.g., eight), and the number of second extension segments extending along the second direction is an odd number (e.g., seven).

In some examples, a first end of the first first extension segment 1215 is connected to the resonant portion 130, and a second end of the first first extension segment 1215 is connected to a first end of the second first extension segment 1213 through the first second extension segment 1214. A second end of the second first extension segment 1213 is connected to a first end of the third first extension segment 1211 through the second second extension segment 1212. A second end of the third first extension segment 1211 is connected to a first end of the fourth first extension segment 129 through the third second extension segment 1210. A second end of the fourth first extension segment 129 is connected to a first end of the fifth first extension segment 127 through the fourth second extension segment 128. A second end of the fifth first extension segment 127 is connected to a first end of the sixth first extension segment 125 through the fifth second extension segment 126. A second end of the sixth first extension segment 125 is connected to a first end of the seventh first extension segment 123 through the sixth second extension segment 124. A second end of the seventh first extension segment 123 is connected to a first end of the eighth first extension segment 121 through the seventh second extension segment 122. A second end of the eighth first extension segment 121 serves as an end of the second element antenna arm 120.

In some examples, widths of each first extension segment and each second extension segment may be substantially the same, such as may be 2 mm. Taking the first element antenna arm 110 as an example, lengths of the second first extension segment 1113 and the third first extension segment 1111 may be substantially the same, lengths of the fourth first extension segment 119 and the fifth first extension segment 117 may be substantially the same, lengths of the sixth first extension segment 115 and the seventh first extension segment 113 may be substantially the same, and lengths of the second first extension segment 1113, the fourth first extension segment 119, the sixth first extension segment 115, and the eighth first extension segment 111 are successively decreased in the second direction.

In some examples, taking the first element antenna arm 110 as an example, the eighth first extension segment 111 and the seventh first extension segment 113 may be substantially symmetrical about a midline of the seventh second extension segment 112 in the second direction D2 (e.g., the midline is parallel to the first direction D1). The seventh first extension segment 113 and the sixth first extension segment 115 may be substantially symmetrical about a midline of the sixth second extension segment 114 in the second direction D2 (e.g., the midline is parallel to the first direction D1). And so on.

In some examples, taking the first element antenna arm 110 as an example, a folding process may be as follows. A straight element antenna arm may be bent at a right angle for a first time to form the first first extension segment 1115, may be bent at a right angle for a second time to form the first second extension segment 1114, may be bent at a right angle for a third time to form the second first extension segment 1113, may be bent at a right angle for a fourth time to form the second second extension segment 1112, . . . , may be bent at a right angle for an thirteenth time to form the seventh second extension segment 112, and may be bent at a right angle for a fourteenth time to form the eighth first extension segment 111.

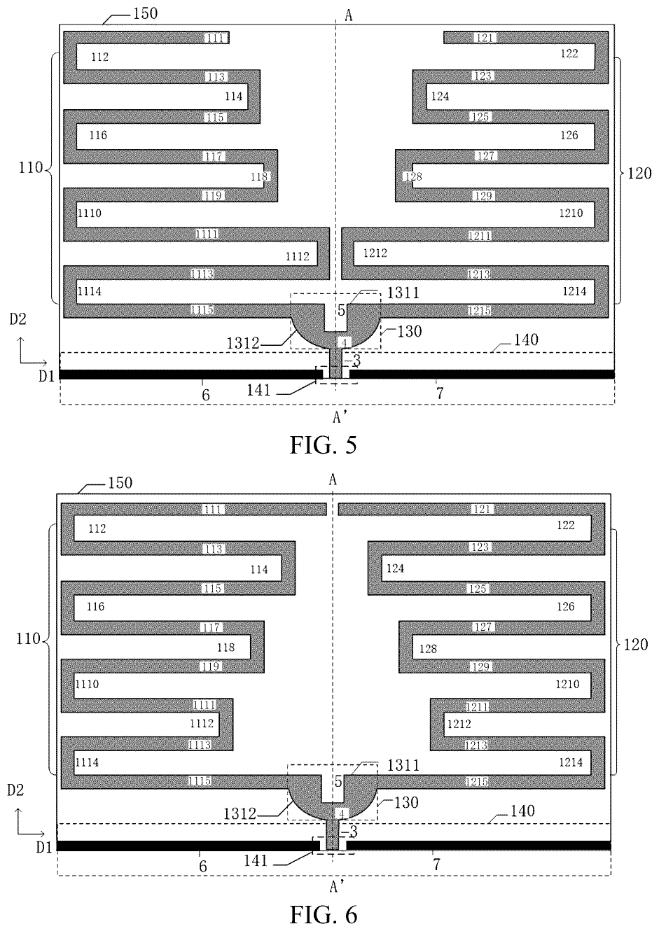

In the present embodiment, folded lengths of two arms of a dipole antenna gradually decrease from the feed end to ends of folded elements. The elements are folded in a decreasing manner, so that at an end near the feed end, current intensity is relatively strong, and if other integrated components are added, it will lead to strong electromagnetic coupling. At an end far away from the feed end, lengths of the folded elements are relatively small, the current intensity becomes weak, and when other integrated components are added, the electromagnetic coupling is relatively small, making it easier to integrate. In addition, the decrease may be a decrease by a same length each time or a decrease by different lengths each time. For example, the decrease shown in FIG. 5 is a decrease by different lengths each time.

FIG. 6 is a schematic plan view of an antenna structure according to at least one embodiment of the present disclosure. The antenna structure presents a symmetrical structure about a symmetry axis, and the symmetry axis may be a central axis AA′ of a substrate. A first direction D1 and a second direction D2 in FIG. 6 are in a same plane, and the first direction D1 is perpendicular to the second direction D2.

In some exemplary implementations, as shown in FIG. 6, the antenna structure of the present exemplary embodiment includes a substrate 150, and a first element antenna arm 110, a second element antenna arm 120, a resonant portion 130, and a feed structure 140 that are disposed on the substrate 150. The first element antenna arm 110 and the second element antenna arm 120 are connected to the resonant portion 130, respectively. The resonant portion 130 is connected to the feed structure 140.

In some examples, a substrate material of the substrate 150 may include, but is not limited to, a Rogers substrate, F4BM, FR4, a liquid crystal material, and the like.

In some examples, as shown in FIG. 6, the resonant portion 130 may include a semicircular structure 4. The semicircular structure 4 may be symmetrical about the symmetry axis. The semicircular structure 4 may include a first arc-shaped edge 1312 and a linear edge 1311. The first arc-shaped edge 1312 may be located on a side of the linear edge 1311 away from the first element antenna arm 110 and the second element antenna arm 120. There is a groove 5 at the linear edge 1311. An orthographic projection of the groove 5 on the substrate 150 may be substantially rectangular, for example, may be rectangular. For example, a length of the orthographic projection of the groove 5 on the substrate 150 along the first direction D1 may be smaller than a length thereof along the second direction D2. An opening of the groove 5 is located on a side of the linear edge 1311 facing away from the feed structure 140. The groove 5 may be substantially symmetrical about the symmetry axis. The feed structure 140 may be connected to the first arc-shaped edge 1312. The feed structure has a feed point 141.

In some examples, as shown in FIG. 6, the antenna structure may further include the feed structure 140. The feed structure 140 may be symmetrical about the symmetry axis. The feed structure 140 may include a first ground plate 6, a second ground plate 7, and a microstrip line 3. The microstrip line 3 is connected to the first arc-shaped edge 1312, and the first ground plate 6 and the second ground plate 7 are located on two sides of the microstrip line 3. The microstrip line 3, the first ground plate 6 and the second ground plate 7 together form a Coplanar Waveguide (CPW) feed structure. In some examples, the first ground plate 6 and the second ground plate 7 may have same dimensions, for example, a length (such as a length along the first direction D1 in FIG. 1A) may be about 44.8 millimeters (mm) and a width (such as a length along the second direction D2 in FIG. 1A) may be about 3 mm.

In some examples, as shown in FIG. 6, the first element antenna arm 110 and the second element antenna arm 120 may be symmetrical about the symmetry axis. The first element antenna arm 110 may include a plurality of first extension segments extending along the first direction D1 (e.g., including a first first extension segment 1115, a second first extension segment 1113, a third first extension segment 1111, a fourth first extension segment 119, a fifth first extension segment 117, a sixth first extension segment 115, a seventh first extension segment 113, and an eighth first extension segment 111), and a plurality of second extension segments extending along the second direction D2 (e.g., including a first second extension segment 1114, a second second extension segment 1112, a third second extension segment 1110, a fourth second extension segment 118, a fifth second extension segment 116, a sixth second extension segment 114, and a seventh second extension segment 112). In this example, the number of first extension segments of the first element antenna arm 110 extending along the first direction is an even number (e.g., eight), and the number of second extension segments extending along the second direction is an odd number (e.g., seven).

In some examples, a first end of the first first extension segment 1115 is connected to the resonant portion 130, and a second end of the first first extension segment 1115 is connected to a first end of the second first extension segment 1113 through the first second extension segment 1114. A second end of the second first extension segment 1113 is connected to a first end of the third first extension segment 1111 through the second second extension segment 1112. A second end of the third first extension segment 1111 is connected to a first end of the fourth first extension segment 119 through the third second extension segment 1110. A second end of the fourth first extension segment 119 is connected to a first end of the fifth first extension segment 117 through the fourth second extension segment 118. A second end of the fifth first extension segment 117 is connected to a first end of the sixth first extension segment 115 through the fifth second extension segment 116. A second end of the sixth first extension segment 115 is connected to a first end of the seventh first extension segment 113 through the sixth second extension segment 114. A second end of the seventh first extension segment 113 is connected to a first end of the eighth first extension segment 111 through the seventh second extension segment 112. A second end of the eighth first extension segment 111 serves as an end of the first element antenna arm 110.

In some examples, the second element antenna arm 120 may include a plurality of first extension segments extending along the first direction D1 (e.g., including a first first extension segment 1215, a second first extension segment 1213, a third first extension segment 1211, a fourth first extension segment 129, a fifth first extension segment 127, a sixth first extension segment 125, a seventh first extension segment 123, and an eighth first extension segment 121), and a plurality of second extension segments extending along the second direction D2 (e.g., including a first second extension segment 1214, a second second extension segment 1212, a third second extension segment 1210, a fourth second extension segment 128, a fifth second extension segment 126, a sixth second extension segment 124, and a seventh second extension segment 122). In this example, the number of first extension segments of the second element antenna arm 120 extending along the first direction is an even number (e.g., eight), and the number of second extension segments extending along the second direction is an odd number (e.g., seven).

In some examples, a first end of the first first extension segment 1215 is connected to the resonant portion 130, and a second end of the first first extension segment 1215 is connected to a first end of the second first extension segment 1213 through the first second extension segment 1214. A second end of the second first extension segment 1213 is connected to a first end of the third first extension segment 1211 through the second second extension segment 1212. A second end of the third first extension segment 1211 is connected to a first end of the fourth first extension segment 129 through the third second extension segment 1210. A second end of the fourth first extension segment 129 is connected to a first end of the fifth first extension segment 127 through the fourth second extension segment 128. A second end of the fifth first extension segment 127 is connected to a first end of the sixth first extension segment 125 through the fifth second extension segment 126. A second end of the sixth first extension segment 125 is connected to a first end of the seventh first extension segment 123 through the sixth second extension segment 124. A second end of the seventh first extension segment 123 is connected to a first end of the eighth first extension segment 121 through the seventh second extension segment 122. A second end of the eighth first extension segment 121 serves as an end of the second element antenna arm 120.

In some examples, widths of each first extension segment and each second extension segment may be substantially the same, such as may be 2 mm. Taking the first element antenna arm 110 as an example, lengths of the second first extension segment 1113 and the third first extension segment 1111 may be substantially the same, lengths of the fourth first extension segment 119 and the fifth first extension segment 117 may be substantially the same, lengths of the sixth first extension segment 115 and the seventh first extension segment 113 may be substantially the same, and lengths of the second first extension segment 1113, the fourth first extension segment 119, the sixth first extension segment 115, and the eighth first extension segment 111 are successively increased in the second direction.

In some examples, taking the first element antenna arm 110 as an example, the eighth first extension segment 111 and the seventh first extension segment 113 may be substantially symmetrical about a midline of the seventh second extension segment 112 in the second direction D2 (e.g., the midline is parallel to the first direction D1). The seventh first extension segment 113 and the sixth first extension segment 115 may be substantially symmetrical about a midline of the sixth second extension segment 114 in the second direction D2 (e.g., the midline is parallel to the first direction D1). And so on.

In some examples, taking the first element antenna arm 110 as an example, a folding process may be as follows. A straight element antenna arm may be bent at a right angle for a first time to form the first first extension segment 1115, may be bent at a right angle for a second time to form the first second extension segment 1114, may be bent at a right angle for a third time to form the second first extension segment 1113, may be bent at a right angle for a fourth time to form the second second extension segment 1112, . . . , may be bent at a right angle for an thirteenth time to form the seventh second extension segment 112, and may be bent at a right angle for a fourteenth time to form the eighth first extension segment 111.

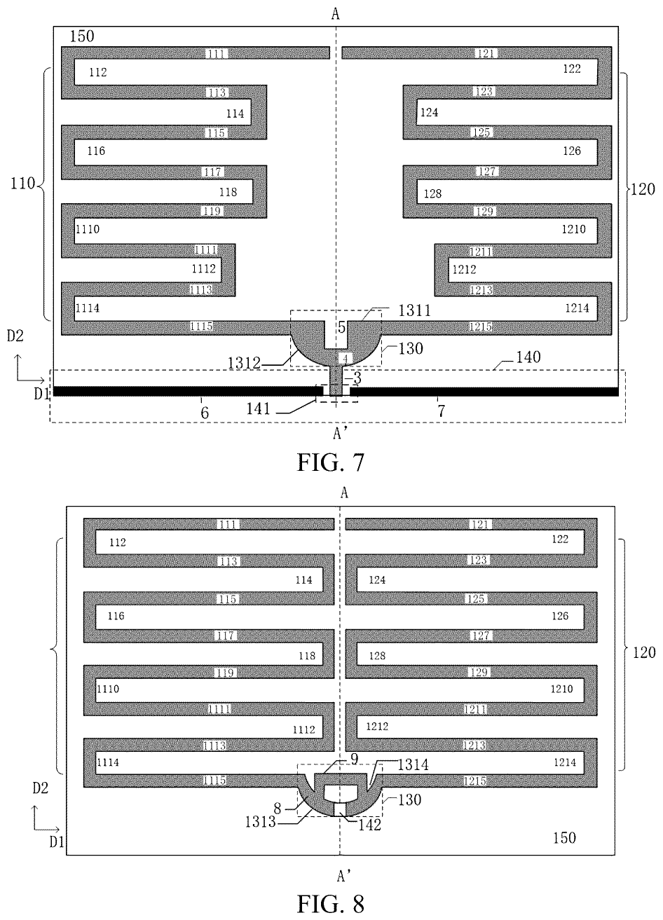

In the present embodiment, folded lengths of two arms of a dipole antenna gradually increase from the feed end to ends of folded elements. Through an increasing manner, coupling effect between the two dipole arms can be reduced, and a distance between the two dipole arms can be extended in the antenna structure to reduce unnecessary coupling. Particularly, the energy is stronger at an end near the feed end, the coupling is greater if the two dipole arms are too close, while at an end far away from the feed end, the energy gradually weakens, and the coupling effect is slightly smaller even if the two arms are relatively close to each other. In addition, the increase may be an increase by a same length each time or an increase by different lengths each time. For example, the increase shown in FIG. 7 is an increase by different lengths each time.

The first element antenna arm 110 and the second element antenna arm 120 shown in FIG. 3 may also be increased or decreased in a manner as shown in FIG. 4, FIG. 5, FIG. 6, and FIG. 7.

FIG. 8 is a schematic plan view of an antenna structure according to at least one embodiment of the present disclosure. The antenna structure presents a symmetrical structure about a symmetry axis, and the symmetry axis may be a central axis AA′ of a substrate. A first direction D1 and a second direction D2 in FIG. 8 are in a same plane, and the first direction D1 is perpendicular to the second direction D2.

In some exemplary implementations, as shown in FIG. 8, the antenna structure of the present exemplary embodiment includes a substrate 150, and a first element antenna arm 110, a second element antenna arm 120, a resonant portion 130, and a feed structure (only a part thereof is shown) that are disposed on the substrate 150. The first element antenna arm 110 and the second element antenna arm 120 are connected to the resonant portion 130, respectively. The resonant portion 130 is connected to the feed structure.

In some examples, a substrate material of the substrate 150 may include, but is not limited to, a Rogers substrate, F4BM, FR4, a liquid crystal material, and the like.

In some examples, as shown in FIG. 8, the resonant portion 130 may include a semicircular ring structure 8. The semicircular ring structure 8 may be symmetrical about the symmetry axis. The semicircular ring structure 8 includes a second arc-shaped edge 1313 and a third arc-shaped edge 1314, and a length of the second arc-shaped edge 1313 is greater than a length of the third arc-shaped edge 1314.

In some examples, as shown in FIG. 8 the feed structure may include a coaxial cable (not shown) and a feed port 142. The feed port 142 may be symmetrical about the symmetry axis. The feed port 142 may be located in the second arc-shaped edge 1313. For example, the feed port 142 may be located on the symmetry axis.

In some examples, as shown in FIG. 8, the resonant portion 130 may further include a short-circuit stub 9, which is symmetrical about the symmetry axis. The short-circuit stub 9 is bridged on the semicircular ring structure 8. The short-circuit stub 9 is connected to the third arc-shaped edge 1314. The short-circuit stub 9 includes one third extension segment extending along a first direction and two fourth extension segments extending along a second direction. The two fourth extension segments are connected by the third extension segment. Each fourth extension segment is connected to the third arc-shaped edge 1314. The first direction intersects with the second direction. For example, the first direction is perpendicular to the second direction.

In some examples, as shown in FIG. 8, the first element antenna arm 110 and the second element antenna arm 120 may be symmetrical about the symmetry axis. The first element antenna arm 110 may include a plurality of first extension segments extending along the first direction D1 (e.g., including a first first extension segment 1115, a second first extension segment 1113, a third first extension segment 1111, a fourth first extension segment 119, a fifth first extension segment 117, a sixth first extension segment 115, a seventh first extension segment 113, and an eighth first extension segment 111), and a plurality of second extension segments extending along the second direction D2 (e.g., including a first second extension segment 1114, a second second extension segment 1112, a third second extension segment 1110, a fourth second extension segment 118, a fifth second extension segment 116, a sixth second extension segment 114, and a seventh second extension segment 112). In this example, the number of first extension segments of the first element antenna arm 110 extending along the first direction is an even number (e.g., eight), and the number of second extension segments extending along the second direction is an odd number (e.g., seven).

In some examples, a first end of the first first extension segment 1115 is connected to the resonant portion 130, and a second end of the first first extension segment 1115 is connected to a first end of the second first extension segment 1113 through the first second extension segment 1114. A second end of the second first extension segment 1113 is connected to a first end of the third first extension segment 1111 through the second second extension segment 1112. A second end of the third first extension segment 1111 is connected to a first end of the fourth first extension segment 119 through the third second extension segment 1110. A second end of the fourth first extension segment 119 is connected to a first end of the fifth first extension segment 117 through the fourth second extension segment 118. A second end of the fifth first extension segment 117 is connected to a first end of the sixth first extension segment 115 through the fifth second extension segment 116. A second end of the sixth first extension segment 115 is connected to a first end of the seventh first extension segment 113 through the sixth second extension segment 114. A second end of the seventh first extension segment 113 is connected to a first end of the eighth first extension segment 111 through the seventh second extension segment 112. A second end of the eighth first extension segment 111 serves as an end of the first element antenna arm 110.

In some examples, the second element antenna arm 120 may include a plurality of first extension segments extending along the first direction D1 (e.g., including a first first extension segment 1215, a second first extension segment 1213, a third first extension segment 1211, a fourth first extension segment 129, a fifth first extension segment 127, a sixth first extension segment 125, a seventh first extension segment 123, and an eighth first extension segment 121), and a plurality of second extension segments extending along the second direction D2 (e.g., including a first second extension segment 1214, a second second extension segment 1212, a third second extension segment 1210, a fourth second extension segment 128, a fifth second extension segment 126, a sixth second extension segment 124, and a seventh second extension segment 122). In this example, the number of first extension segments of the second element antenna arm 120 extending along the first direction is an even number (e.g., eight), and the number of second extension segments extending along the second direction is an odd number (e.g., seven).

In some examples, a first end of the first first extension segment 1215 is connected to the resonant portion 130, and a second end of the first first extension segment 1215 is connected to a first end of the second first extension segment 1213 through the first second extension segment 1214. A second end of the second first extension segment 1213 is connected to a first end of the third first extension segment 1211 through the second second extension segment 1212. A second end of the third first extension segment 1211 is connected to a first end of the fourth first extension segment 129 through the third second extension segment 1210. A second end of the fourth first extension segment 129 is connected to a first end of the fifth first extension segment 127 through the fourth second extension segment 128. A second end of the fifth first extension segment 127 is connected to a first end of the sixth first extension segment 125 through the fifth second extension segment 126. A second end of the sixth first extension segment 125 is connected to a first end of the seventh first extension segment 123 through the sixth second extension segment 124. A second end of the seventh first extension segment 123 is connected to a first end of the eighth first extension segment 121 through the seventh second extension segment 122. A second end of the eighth first extension segment 121 serves as an end of the second element antenna arm 120.

In some examples, widths of each first extension segment and each second extension segment may be substantially the same, such as may be 2 mm. Lengths of the second first extension segment 1113, the third first extension segment 1111, the fourth first extension segment 119, the fifth first extension segment 117, the sixth first extension segment 115, the seventh first extension segment 113, and the eighth first extension segment 111 may be substantially the same.

In some examples, the eighth first extension segment 111 and the seventh first extension segment 113 may be substantially symmetrical about a midline of the seventh second extension segment 112 in the second direction D2 (e.g., the midline is parallel to the first direction D1). The seventh first extension segment 113 and the sixth first extension segment 115 may be substantially symmetrical about a midline of the sixth second extension segment 114 in the second direction D2 (e.g., the midline is parallel to the first direction D1). And so on.

In some examples, taking the first element antenna arm 110 as an example, a folding process may be as follows. A straight element antenna arm may be bent at a right angle for a first time to form the first first extension segment 1115, may be bent at a right angle for a second time to form the first second extension segment 1114, may be bent at a right angle for a third time to form the second first extension segment 1113, may be bent at a right angle for a fourth time to form the second second extension segment 1112, . . . , may be bent at a right angle for an thirteenth time to form the seventh second extension segment 112, and may be bent at a right angle for a fourteenth time to form the eighth first extension segment 111.

In the present embodiment, the feed port 142 is a rectangular feed port, the feed port 142 serves as a feed point, and the antenna is fed by a coaxial feeding manner. The feed port 142 is connected to the semicircular ring structure 8. In the present embodiment, there are two dipole antenna arms responsible for antenna resonance, impedance matching and performance optimization. An electrical length required for antenna resonance is compressed by a folded symmetrical element structure in a square wave shape. The short-circuit stub serves as a main matching structure to form a closed circulation current and gather energy. By adjusting the folded lengths of element arms and spacing between elements (for example, adjusting according to a simulated structure, if simulation results show that an inductance is strong, then the folded length is increased or the spacing between the elements is reduced to increase a capacitance value for synthesis), currents in a vertical direction are cancelled out, and the gathered energy is radiated along a gap between two elements, thus improving gain.

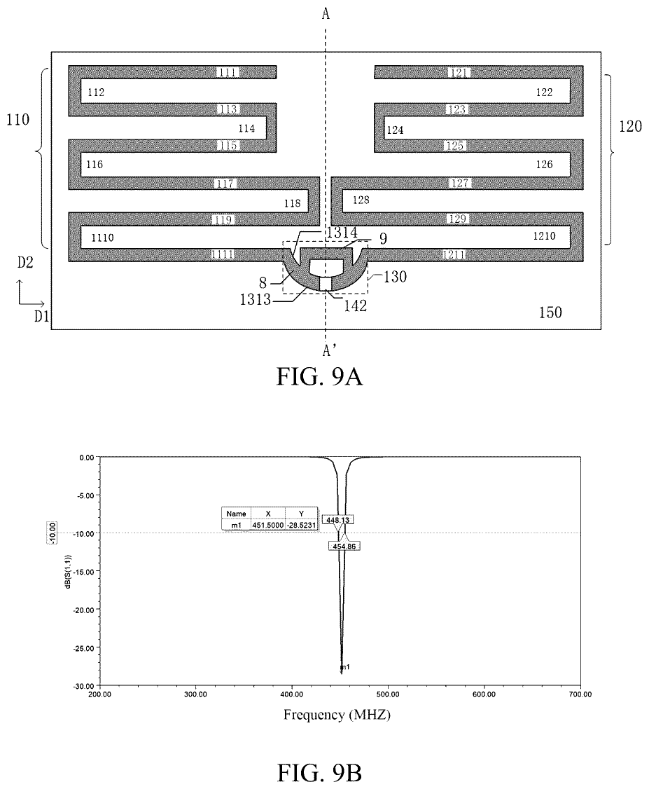

FIG. 9A is a schematic plan view of an antenna structure according to at least one embodiment of the present disclosure. The antenna structure presents a symmetrical structure about a symmetry axis, and the symmetry axis may be a central axis AA′ of a substrate. A first direction D1 and a second direction D2 in FIG. 9A are in a same plane, and the first direction D1 is perpendicular to the second direction D2.

In some exemplary implementations, as shown in FIG. 9A, the antenna structure of the present exemplary embodiment includes a substrate 150, and a first element antenna arm 110, a second element antenna arm 120, a resonant portion 130, and a feed structure (only a part thereof is shown) that are disposed on the substrate 150. The first element antenna arm 110 and the second element antenna arm 120 are connected to the resonant portion 130, respectively. The resonant portion 130 is connected to the feed structure.

In some examples, a substrate material of the substrate 150 may include, but is not limited to, a Rogers substrate, F4BM, FR4, a liquid crystal material, and the like.

In some examples, as shown in FIG. 9A, the resonant portion 130 may include a semicircular ring structure 8. The semicircular ring structure 8 may be symmetrical about the symmetry axis. The semicircular ring structure 8 includes a second arc-shaped edge 1313 and a third arc-shaped edge 1314, and a length of the second arc-shaped edge 1313 is greater than a length of the third arc-shaped edge 1314.

In some examples, as shown in FIG. 9A, the feed structure may include a coaxial cable (not shown) and a feed port 142. The feed port 142 may be symmetrical about the symmetry axis. The feed port 142 may be located in the second arc-shaped edge 1313. For example, the feed port 142 may be located on the symmetry axis.

In some examples, as shown in FIG. 9A, the resonant portion 130 may further include a short-circuit stub 9, which is symmetrical about the symmetry axis. The short-circuit stub 9 is bridged on the semicircular ring structure 8. The short-circuit stub 9 is connected to the third arc-shaped edge 1314. The short-circuit stub 9 includes one third extension segment extending along a first direction and two fourth extension segments extending along a second direction. The two fourth extension segments are connected by the third extension segment. Each fourth extension segment is connected to the third arc-shaped edge 1314. The first direction intersects with the second direction. For example, the first direction is perpendicular to the second direction.

In some examples, as shown in FIG. 9A, the first element antenna arm 110 and the second element antenna arm 120 may be symmetrical about the symmetry axis. The first element antenna arm 110 may include a plurality of first extension segments extending along the first direction D1 (e.g., including a first first extension segment 1111, a second first extension segment 119, a third first extension segment 117, a fourth first extension segment 115, a fifth first extension segment 113, and a sixth first extension segment 111), and a plurality of second extension segments extending along the second direction D2 (e.g., including a first second extension segment 1110, a second second extension segment 118, a third second extension segment 116, a fourth second extension segment 114, and a fifth second extension segment 112). In this example, the number of first extension segments of the first element antenna arm 110 extending along the first direction is an even number (e.g., six), and the number of second extension segments extending along the second direction is an odd number (e.g., five).

In some examples, a first end of the first first extension segment 1111 is connected to the resonant portion 130, and a second end of the first first extension segment 1111 is connected to a first end of the second first extension segment 119 through the first second extension segment 1110. A second end of the second first extension segment 119 is connected to a first end of the third first extension segment 117 through the second second extension segment 118. A second end of the third first extension segment 117 is connected to a first end of the fourth first extension segment 115 through the third second extension segment 116. A second end of the fourth first extension segment 115 is connected to a first end of the fifth first extension segment 113 through the fourth second extension segment 114. A second end of the fifth first extension segment 113 is connected to a first end of the sixth first extension segment 111 through the fifth second extension segment 112. A second end of the sixth first extension segment 111 serves as an end of the first element antenna arm 110.

In some examples, the second element antenna arm 120 may include a plurality of first extension segments extending along the first direction D1 (e.g., including a first first extension segment 1211, a second first extension segment 129, a third first extension segment 127, a fourth first extension segment 125, a fifth first extension segment 123, and a sixth first extension segment 121), and a plurality of second extension segments extending along the second direction D2 (e.g., including a first second extension segment 1210, a second second extension segment 128, a third second extension segment 126, a fourth second extension segment 124, and a fifth second extension segment 122). In this example, the number of first extension segments of the second element antenna arm 120 extending along the first direction is an even number (for example, six), and the number of second extension segments extending along the second direction is an odd number (for example, five).

In some examples, a first end of the first first extension segment 1211 is connected to the resonant portion 130, and a second end of the first first extension segment 1211 is connected to a first end of the second first extension segment 129 through the first second extension segment 1210. A second end of the second first extension segment 129 is connected to a first end of the third first extension segment 127 through the second second extension segment 128. A second end of the third first extension segment 127 is connected to a first end of the fourth first extension segment 125 through the third second extension segment 126. A second end of the fourth first extension segment 125 is connected to a first end of the fifth first extension segment 123 through the fourth second extension segment 124. A second end of the fifth first extension segment 123 is connected to a first end of the sixth first extension segment 121 through the fifth second extension segment 122. A second end of the sixth first extension segment 121 serves as an end of the second element antenna arm 120.

In some examples, widths of each first extension segment and each second extension segment may be substantially the same, such as may be 2 mm. Lengths of the second first extension segment 119 and the third first extension segment 117 may be substantially the same, lengths of the fourth first extension segment 115 and the fifth first extension segment 113 may be substantially the same, and lengths of the sixth first extension segment 111 and the fifth first extension segment 113 may be substantially the same. Lengths of the second first extension segment 119 and the fourth first extension segment 115 are successively decreased in the second direction.

In some examples, the sixth first extension segment 111 and the fifth first extension segment 113 may be substantially symmetrical about a midline of the fifth second extension segment 112 in the second direction D2 (e.g., the midline is parallel to the first direction D1). The fifth first extension segment 113 and the fourth first extension segment 115 may be substantially symmetrical about a midline of the fourth second extension segment 114 in the second direction D2 (e.g., the midline is parallel to the first direction D1). And so on.

In some examples, taking the first element antenna arm 110 as an example, a folding process may be as follows. A straight element antenna arm may be bent at a right angle for a first time to form the first first extension segment 1111, may be bent at a right angle for a second time to form the first second extension segment 1110, may be bent at a right angle for a third time to form the second first extension segment 119, may be bent at a right angle for a fourth time to form the second second extension segment 118, . . . , may be bent at a right angle for a ninth time to form the fifth second extension segment 112, and may be bent at a right angle for a tenth time to form the sixth first extension segment 111.

In the present embodiment, the feed port 142 is a rectangular feed port, the feed port 142 serves as a feed point, and the antenna is fed by a coaxial feeding manner. The feed port 142 is connected to the semicircular ring structure 8. In the present embodiment, there are two dipole antenna arms responsible for antenna resonance, impedance matching and performance optimization. An electrical length required for antenna resonance is compressed by a folded symmetrical element structure in a square wave shape. The short-circuit stub serves as a main matching structure to form a closed circulation current and gather energy. By adjusting folded lengths of element arms and spacing between elements (for example, according to simulation results, lengths of the elements may be reduced and the spacing between the elements may be increased to reduce an occurrence of a reverse current), so that currents in a vertical direction are cancelled out, and the gathered energy is radiated along a gap between two elements, thus improving gain.

In the present embodiment, folded lengths of two arms of a dipole antenna gradually increase from the feed point to ends of folded elements. Through an increasing manner, coupling effect between the two dipole arms can be reduced, and a distance between the two dipole arms can be extended in the antenna structure to reduce unnecessary coupling. Particularly, the energy is stronger at an end near the feed end, the coupling is greater if the two dipole arms are too close, while at an end far away from the feed end, the coupling effect is slightly smaller even if the two arms are relatively close to each other, and the energy gradually weakens. In addition, the increase may be an increase by a same length each time or an increase by different lengths each time.

In the present embodiment, each element antenna arm is bent at a right angle for ten times to form a folded structure in a square wave shape. Physical characteristics of the antenna are effectively reduced by folding element radiators multiple times. An overall size of the folded antenna is 90 mm×50 mm×0.8 mm, and an actual size at a center operating frequency does not exceed a size of a spherical antenna with r=λ/2π, which meets size standards for electrically small antennas. Several parts of the high-gain miniaturized dipole folded antenna work together, so that an effective operating frequency band of the present embodiment is 448.13 MHz-454.86 MHz, and a bandwidth is 6.7 MHz, as shown in FIGS. 9B and 9C. Moreover, at a center frequency point, a maximum gain of 1.9 dB and an echo loss of −28.52 dB are achieved, and one or more performance indicators are good.

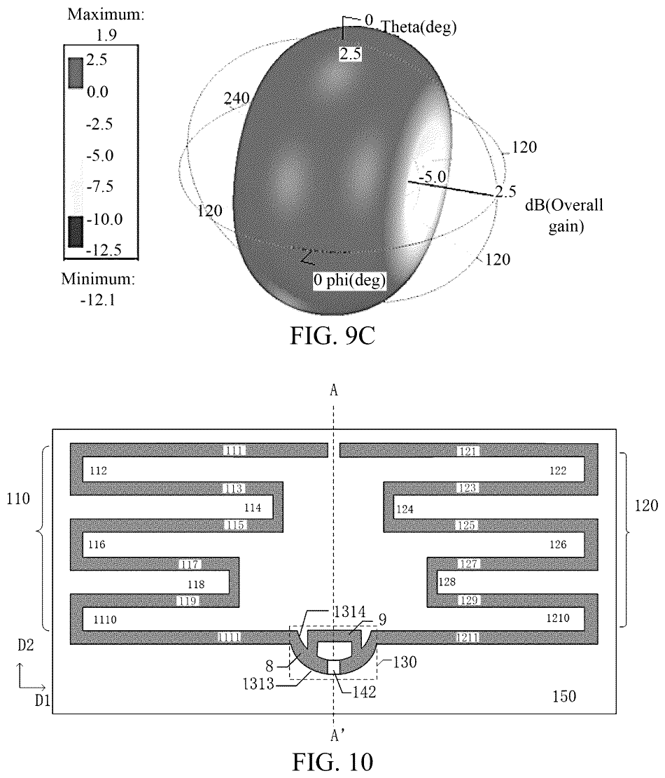

FIG. 10 is a schematic plan view of an antenna structure according to at least one embodiment of the present disclosure. The antenna structure presents a symmetrical structure about a symmetry axis, and the symmetry axis may be a central axis AA′ of a substrate. A first direction D1 and a second direction D2 in FIG. 10 are in a same plane, and the first direction D1 is perpendicular to the second direction D2.

In some exemplary implementations, as shown in FIG. 10, the antenna structure of the present exemplary embodiment includes a substrate 150, and a first element antenna arm 110, a second element antenna arm 120, a resonant portion 130, and a feed structure (only a part thereof is shown) that are disposed on the substrate 150. The first element antenna arm 110 and the second element antenna arm 120 are connected to the resonant portion 130, respectively. The resonant portion 130 is connected to the feed structure.

In some examples, a substrate material of the substrate 150 may include, but is not limited to, a Rogers substrate, F4BM, FR4, a liquid crystal material, and the like.

In some examples, as shown in FIG. 10, the resonant portion 130 may include a semicircular ring structure 8. The semicircular ring structure 8 may be symmetrical about the symmetry axis. The semicircular ring structure 8 includes a second arc-shaped edge 1313 and a third arc-shaped edge 1314, and a length of the second arc-shaped edge 1313 is greater than a length of the third arc-shaped edge 1314.

In some examples, as shown in FIG. 10, the feed structure may include a coaxial cable (not shown) and a feed port 142. The feed port 142 may be located between the second arc-shaped edge 1313 and the third arc-shaped edge 1314. The feed port 142 may be symmetrical about the symmetry axis. For example, the feed port 142 may be located on the symmetry axis.

In some examples, as shown in FIG. 10, the resonant portion 130 may further include a short-circuit stub 9, which is symmetrical about the symmetry axis. The short-circuit stub 9 is bridged on the semicircular ring structure 8. The short-circuit stub 9 is connected to the third arc-shaped edge 1314. The short-circuit stub 9 includes one third extension segment extending along a first direction and two fourth extension segments extending along a second direction. The two fourth extension segments are connected by the third extension segment. Each fourth extension segment is connected to the third arc-shaped edge 1314. The first direction intersects with the second direction. For example, the first direction is perpendicular to the second direction.

In some examples, as shown in FIG. 10, the first element antenna arm 110 and the second element antenna arm 120 may be symmetrical about the symmetry axis. The first element antenna arm 110 may include a plurality of first extension segments extending along the first direction D1 (e.g., including a first first extension segment 1111, a second first extension segment 119, a third first extension segment 117, a fourth first extension segment 115, a fifth first extension segment 113, and a sixth first extension segment 111), and a plurality of second extension segments extending along the second direction D2 (e.g., including a first second extension segment 1110, a second second extension segment 118, a third second extension segment 116, a fourth second extension segment 114, and a fifth second extension segment 112). In this example, the number of first extension segments of the first element antenna arm 110 extending along the first direction is an even number (e.g., six), and the number of second extension segments extending along the second direction is an odd number (e.g., five).

In some examples, a first end of the first first extension segment 1111 is connected to the resonant portion 130, and a second end of the first first extension segment 1111 is connected to a first end of the second first extension segment 119 through the first second extension segment 1110. A second end of the second first extension segment 119 is connected to a first end of the third first extension segment 117 through the second second extension segment 118. A second end of the third first extension segment 117 is connected to a first end of the fourth first extension segment 115 through the third second extension segment 116. A second end of the fourth first extension segment 115 is connected to a first end of the fifth first extension segment 113 through the fourth second extension segment 114. A second end of the fifth first extension segment 113 is connected to a first end of the sixth first extension segment 111 through the fifth second extension segment 112. A second end of the sixth first extension segment 111 serves as an end of the first element antenna arm 110.

In some examples, the second element antenna arm 120 may include a plurality of first extension segments extending along the first direction D1 (e.g., including a first first extension segment 1211, a second first extension segment 129, a third first extension segment 127, a fourth first extension segment 125, a fifth first extension segment 123, and a sixth first extension segment 121), and a plurality of second extension segments extending along the second direction D2 (e.g., including a first second extension segment 1210, a second second extension segment 128, a third second extension segment 126, a fourth second extension segment 124, and a fifth second extension segment 122). In this example, the number of first extension segments of the second element antenna arm 120 extending along the first direction is an even number (for example, six), and the number of second extension segments extending along the second direction is an odd number (for example, five).

In some examples, a first end of the first first extension segment 1211 is connected to the resonant portion 130, and a second end of the first first extension segment 1211 is connected to a first end of the second first extension segment 129 through the first second extension segment 1210. A second end of the second first extension segment 129 is connected to a first end of the third first extension segment 127 through the second second extension segment 128. A second end of the third first extension segment 127 is connected to a first end of the fourth first extension segment 125 through the third second extension segment 126. A second end of the fourth first extension segment 125 is connected to a first end of the fifth first extension segment 123 through the fourth second extension segment 124. A second end of the fifth first extension segment 123 is connected to a first end of the sixth first extension segment 121 through the fifth second extension segment 122. A second end of the sixth first extension segment 121 serves as an end of the second element antenna arm 120.

In some examples, widths of each first extension segment and each second extension segment may be substantially the same, such as may be 2 mm. Lengths of the second first extension segment 119 and the third first extension segment 117 may be substantially the same, lengths of the fourth first extension segment 115 and the fifth first extension segment 113 may be substantially the same, and lengths of the second first extension segment 119, the fourth first extension segment 115, and the sixth first extension segment 111 are successively increased in the second direction.

In some examples, the sixth first extension segment 111 and the fifth first extension segment 113 may be substantially symmetrical about a midline of the fifth second extension segment 112 in the second direction D2 (e.g., the midline is parallel to the first direction D1). The fifth first extension segment 113 and the fourth first extension segment 115 may be substantially symmetrical about a midline of the fourth second extension segment 114 in the second direction D2 (e.g., the midline is parallel to the first direction D1). And so on.

In some examples, taking the first element antenna arm 110 as an example, a folding process may be as follows. A straight element antenna arm may be bent at a right angle for a first time to form the first first extension segment 1111, may be bent at a right angle for a second time to form the first second extension segment 1110, may be bent at a right angle for a third time to form the second first extension segment 119, may be bent at a right angle for a fourth time to form the second second extension segment 118, . . . , may be bent at a right angle for a ninth time to form the fifth second extension segment 112, and may be bent at a right angle for a tenth time to form the sixth first extension segment 111.

In the present embodiment, the feed port 142 is a rectangular feed port, the feed port 142 serves as a feed point, and the antenna is fed by a coaxial feeding manner. The feed port 142 is connected to the semicircular ring structure 8. In the present embodiment, there are two dipole antenna arms responsible for antenna resonance, impedance matching and performance optimization. An electrical length required for antenna resonance is compressed by a folded symmetrical element structure in a square wave shape. The short-circuit stub serves as a main matching structure to form a closed circulation current and gather energy. By adjusting folded lengths of element arms and spacing between elements, currents in a vertical direction are cancelled out, and the gathered energy is radiated along a gap between two elements, thus improving gain.

In the present embodiment, folded lengths of the two arms of the dipole antenna gradually increase from the feed point to ends of folded elements. Through an increasing manner, coupling effect between the two dipole arms can be reduced, and a distance between the two dipole arms can be extended in the antenna structure to reduce unnecessary coupling. Particularly, the energy is stronger at an end near the feed end, the coupling is greater if the two dipole arms are too close, while at an end far away from the feed end, the coupling effect is slightly smaller even if the two arms are relatively close to each other, and the energy gradually weakens. In addition, the increase may be an increase by a same length each time or an increase by different lengths each time.

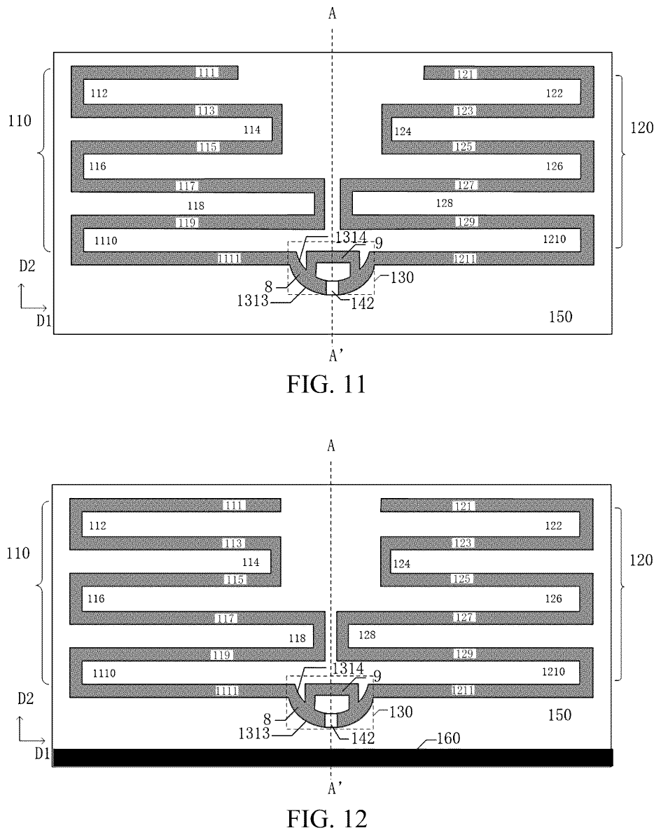

FIG. 11 is a schematic plan view of an antenna structure according to at least one embodiment of the present disclosure. The antenna structure presents a symmetrical structure about a symmetry axis, and the symmetry axis may be a central axis AA′ of a substrate. A first direction D1 and a second direction D2 in FIG. 11 are in a same plane, and the first direction D1 is perpendicular to the second direction D2.

In some exemplary implementations, as shown in FIG. 11, the antenna structure of the present exemplary embodiment includes a substrate 150, and a first element antenna arm 110, a second element antenna arm 120, a resonant portion 130, and a feed structure that are disposed on the substrate 150. The first element antenna arm 110 and the second element antenna arm 120 are connected to the resonant portion 130, respectively. The resonant portion 130 is connected to the feed structure.

In some examples, a substrate material of the substrate 150 may include, but is not limited to, a Rogers substrate, F4BM, FR4, a liquid crystal material, and the like.

In some examples, as shown in FIG. 11, the resonant portion 130 may include a semicircular ring structure 8. The semicircular ring structure 8 may be symmetrical about the symmetry axis. The semicircular ring structure 8 includes a second arc-shaped edge 1313 and a third arc-shaped edge 1314, and a length of the second arc-shaped edge 1313 is greater than a length of the third arc-shaped edge 1314.

In some examples, as shown in FIG. 11, the feed structure may include a coaxial cable (not shown) and a feed port 142. The feed port 142 may be located in the second arc-shaped edge 1313. The feed port 142 may be symmetrical about the symmetry axis. For example, the feed port 142 may be located on the symmetry axis.

In some examples, as shown in FIG. 11, the resonant portion 130 may further include a short-circuit stub 9, which is symmetrical about the symmetry axis. The short-circuit stub 9 is bridged on the semicircular ring structure 8. The short-circuit stub 9 is connected to the third arc-shaped edge 1314. The short-circuit stub 9 includes one third extension segment extending along a first direction and two fourth extension segments extending along a second direction. The two fourth extension segments are connected by the third extension segment. Each fourth extension segment is connected to the third arc-shaped edge 1314. The first direction intersects with the second direction. For example, the first direction is perpendicular to the second direction.

In some examples, as shown in FIG. 11, the first element antenna arm 110 and the second element antenna arm 120 may be symmetrical about the symmetry axis. The first element antenna arm 110 may include a plurality of first extension segments extending along the first direction D1 (e.g., including a first first extension segment 1111, a second first extension segment 119, a third first extension segment 117, a fourth first extension segment 115, a fifth first extension segment 113, and a sixth first extension segment 111), and a plurality of second extension segments extending along the second direction D2 (e.g., including a first second extension segment 1110, a second second extension segment 118, a third second extension segment 116, a fourth second extension segment 114, and a fifth second extension segment 112). In this example, the number of first extension segments of the first element antenna arm 110 extending along the first direction is an even number (e.g., six), and the number of second extension segments extending along the second direction is an odd number (e.g., five).

In some examples, a first end of the first first extension segment 1111 is connected to the resonant portion 130, and a second end of the first first extension segment 1111 is connected to a first end of the second first extension segment 119 through the first second extension segment 1110. A second end of the second first extension segment 119 is connected to a first end of the third first extension segment 117 through the second second extension segment 118. A second end of the third first extension segment 117 is connected to a first end of the fourth first extension segment 115 through the third second extension segment 116. A second end of the fourth first extension segment 115 is connected to a first end of the fifth first extension segment 113 through the fourth second extension segment 114. A second end of the fifth first extension segment 113 is connected to a first end of the sixth first extension segment 111 through the fifth second extension segment 112. A second end of the sixth first extension segment 111 serves as an end of the first element antenna arm 110.

In some examples, the second element antenna arm 120 may include a plurality of first extension segments extending along the first direction D1 (e.g., including a first first extension segment 1211, a second first extension segment 129, a third first extension segment 127, a fourth first extension segment 125, a fifth first extension segment 123, and a sixth first extension segment 121), and a plurality of second extension segments extending along the second direction D2 (e.g., including a first second extension segment 1210, a second second extension segment 128, a third second extension segment 126, a fourth second extension segment 124, and a fifth second extension segment 122). In this example, the number of first extension segments of the second element antenna arm 120 extending along the first direction is an even number (for example, six), and the number of second extension segments extending along the second direction is an odd number (for example, five).

In some examples, a first end of the first first extension segment 1211 is connected to the resonant portion 130, and a second end of the first first extension segment 1211 is connected to a first end of the second first extension segment 129 through the first second extension segment 1210. A second end of the second first extension segment 129 is connected to a first end of the third first extension segment 127 through the second second extension segment 128. A second end of the third first extension segment 127 is connected to a first end of the fourth first extension segment 125 through the third second extension segment 126. A second end of the fourth first extension segment 125 is connected to a first end of the fifth first extension segment 123 through the fourth second extension segment 124. A second end of the fifth first extension segment 123 is connected to a first end of the sixth first extension segment 121 through the fifth second extension segment 122. A second end of the sixth first extension segment 121 serves as an end of the second element antenna arm 120.

In some examples, widths of each first extension segment and each second extension segment may be substantially the same, such as may be 2 mm. Lengths of the second first extension segment 119 and the third first extension segment 117 may be substantially the same, lengths of the fourth first extension segment 115 and the fifth first extension segment 113 may be substantially the same, and lengths of the second first extension segment 119, the fourth first extension segment 115, and the sixth first extension segment 111 are successively decreased in the second direction.

In some examples, the sixth first extension segment 111 and the fifth first extension segment 113 may be substantially symmetrical about a midline of the fifth second extension segment 112 in the second direction D2 (e.g., the midline is parallel to the first direction D1). The fifth first extension segment 113 and the fourth first extension segment 115 may be substantially symmetrical about a midline of the fourth second extension segment 114 in the second direction D2 (e.g., the midline is parallel to the first direction D1). And so on.

In some examples, taking the first element antenna arm 110 as an example, a folding process may be as follows. A straight element antenna arm may be bent at a right angle for a first time to form the first first extension segment 1111, may be bent at a right angle for a second time to form the first second extension segment 1110, may be bent at a right angle for a third time to form the second first extension segment 119, may be bent at a right angle for a fourth time to form the second second extension segment 118, . . . , may be bent at a right angle for a ninth time to form the fifth second extension segment 112, and may be bent at a right angle for a tenth time to form the sixth first extension segment 111.

In the present embodiment, the feed port 142 is a rectangular feed port, the feed port 142 serves as a feed point, and the antenna is fed by a coaxial feeding manner. The feed port 142 is connected to the semicircular ring structure 8. In the present embodiment, there are two dipole antenna arms responsible for antenna resonance, impedance matching and performance optimization. An electrical length required for antenna resonance is compressed by a folded symmetrical element structure in a square wave shape. The short-circuit stub serves as a main matching structure to form a closed circulation current and gather energy. By adjusting folded lengths of element arms and spacing between elements, currents in a vertical direction are cancelled out, and the gathered energy is radiated along a gap between two elements, thus improving gain.

In the present embodiment, folded lengths of two arms of a dipole antenna gradually decrease from the feed point to ends of folded elements. The elements are folded in a decreasing manner, so that at an end near the feed end, current intensity is relatively strong, and if other integrated components are added, it will lead to strong electromagnetic coupling. At an end far away from the feed end, lengths of the folded elements are relatively small, the current intensity becomes weak, and when other integrated components are added, the electromagnetic coupling is relatively small, making it easier to integrate. In addition, the decrease may be a decrease by a same length each time or a decrease by different lengths each time.

FIG. 12 is a schematic plan view of an antenna structure according to at least one embodiment of the present disclosure. The antenna structure presents a symmetrical structure about a symmetry axis, and the symmetry axis may be a central axis AA′ of a substrate. A first direction D1 and a second direction D2 in FIG. 12 are in a same plane, and the first direction D1 is perpendicular to the second direction D2.

In some exemplary implementations, as shown in FIG. 12, the antenna structure of the present exemplary embodiment includes a substrate 150, and a first element antenna arm 110, a second element antenna arm 120, a resonant portion 130, a feed structure, and a reflective ground 160 that are disposed on the substrate 150. The first element antenna arm 110 and the second element antenna arm 120 are connected to the resonant portion 130, respectively. The resonant portion 130 is connected to the feed structure.

In some examples, a substrate material of the substrate 150 may include, but is not limited to, a Rogers substrate, F4BM, FR4, a liquid crystal material, and the like.

In some examples, as shown in FIG. 12, the resonant portion 130 may include a semicircular ring structure 8. The semicircular ring structure 8 may be symmetrical about the symmetry axis. The semicircular ring structure 8 includes a second arc-shaped edge 1313 and a third arc-shaped edge 1314, and a length of the second arc-shaped edge 1313 is greater than a length of the third arc-shaped edge 1314.

In some examples, as shown in FIG. 12, the feed structure may be symmetrical about the symmetry axis. The feed structure may include a coaxial cable (not shown) and a feed port 142. The feed port 142 may be located in the second arc-shaped edge 1313. For example, the feed port 142 may be located on the symmetry axis.

In some examples, as shown in FIG. 12, the resonant portion 130 may further include a short-circuit stub 9, which is symmetrical about the symmetry axis. The short-circuit stub 9 is bridged on the semicircular ring structure 8. The short-circuit stub 9 is connected to the third arc-shaped edge 1314. The short-circuit stub 9 includes one third extension segment extending along a first direction and two fourth extension segments extending along a second direction. The two fourth extension segments are connected by the third extension segment. Each fourth extension segment is connected to the third arc-shaped edge 1314. The first direction intersects with the second direction. For example, the first direction is perpendicular to the second direction.

In some examples, as shown in FIG. 12, the antenna structure further includes a reflective ground 160. The reflective ground 160 is located on a side of the feed port 142 away from the resonant portion 130.

In some examples, as shown in FIG. 12, the first element antenna arm 110 and the second element antenna arm 120 may be symmetrical about the symmetry axis. The first element antenna arm 110 may include a plurality of first extension segments extending along the first direction D1 (e.g., including a first first extension segment 1111, a second first extension segment 119, a third first extension segment 117, a fourth first extension segment 115, a fifth first extension segment 113, and a sixth first extension segment 111), and a plurality of second extension segments extending along the second direction D2 (e.g., including a first second extension segment 1110, a second second extension segment 118, a third second extension segment 116, a fourth second extension segment 114, and a fifth second extension segment 112). In this example, the number of first extension segments of the first element antenna arm 110 extending along the first direction is an even number (e.g., six), and the number of second extension segments extending along the second direction is an odd number (e.g., five).

In some examples, a first end of the first first extension segment 1111 is connected to the resonant portion 130, and a second end of the first first extension segment 1111 is connected to a first end of the second first extension segment 119 through the first second extension segment 1110. A second end of the second first extension segment 119 is connected to a first end of the third first extension segment 117 through the second second extension segment 118. A second end of the third first extension segment 117 is connected to a first end of the fourth first extension segment 115 through the third second extension segment 116. A second end of the fourth first extension segment 115 is connected to a first end of the fifth first extension segment 113 through the fourth second extension segment 114. A second end of the fifth first extension segment 113 is connected to a first end of the sixth first extension segment 111 through the fifth second extension segment 112. A second end of the sixth first extension segment 111 serves as an end of the first element antenna arm 110.

In some examples, the second element antenna arm 120 may include a plurality of first extension segments extending along the first direction D1 (e.g., including a first first extension segment 1211, a second first extension segment 129, a third first extension segment 127, a fourth first extension segment 125, a fifth first extension segment 123, and a sixth first extension segment 121), and a plurality of second extension segments extending along the second direction D2 (e.g., including a first second extension segment 1210, a second second extension segment 128, a third second extension segment 126, a fourth second extension segment 124, and a fifth second extension segment 122). In this example, the number of first extension segments of the second element antenna arm 120 extending along the first direction is an even number (for example, six), and the number of second extension segments extending along the second direction is an odd number (for example, five).

In some examples, a first end of the first first extension segment 1211 is connected to the resonant portion 130, and a second end of the first first extension segment 1211 is connected to a first end of the second first extension segment 129 through the first second extension segment 1210. A second end of the second first extension segment 129 is connected to a first end of the third first extension segment 127 through the second second extension segment 128. A second end of the third first extension segment 127 is connected to a first end of the fourth first extension segment 125 through the third second extension segment 126. A second end of the fourth first extension segment 125 is connected to a first end of the fifth first extension segment 123 through the fourth second extension segment 124. A second end of the fifth first extension segment 123 is connected to a first end of the sixth first extension segment 121 through the fifth second extension segment 122. A second end of the sixth first extension segment 121 serves as an end of the second element antenna arm 120.

In some examples, widths of each first extension segment and each second extension segment may be substantially the same, such as may be 2 mm. Lengths of the second first extension segment 119 and the third first extension segment 117 may be substantially the same, lengths of the fourth first extension segment 115 and the fifth first extension segment 113 may be substantially the same, and lengths of the sixth first extension segment 111 and the fifth first extension segment 113 may be substantially the same. Lengths of the second first extension segment 119 and the fourth first extension segment 115 are successively decreased in the second direction.

In some examples, the sixth first extension segment 111 and the fifth first extension segment 113 may be substantially symmetrical about a midline of the fifth second extension segment 112 in the second direction D2 (e.g., the midline is parallel to the first direction D1). The fifth first extension segment 113 and the fourth first extension segment 115 may be substantially symmetrical about a midline of the fourth second extension segment 114 in the second direction D2 (e.g., the midline is parallel to the first direction D1). And so on.

In some examples, taking the first element antenna arm 110 as an example, a folding process may be as follows. A straight element antenna arm may be bent at a right angle for a first time to form the first first extension segment 1111, may be bent at a right angle for a second time to form the first second extension segment 1110, may be bent at a right angle for a third time to form the second first extension segment 119, may be bent at a right angle for a fourth time to form the second second extension segment 118, . . . , may be bent at a right angle for a ninth time to form the fifth second extension segment 112, and may be bent at a right angle for a tenth time to form the sixth first extension segment 111.

In some exemplary embodiments, the decrease of lengths of extension segments may be a decrease by a same length each time or a decrease by different lengths each time. In some exemplary embodiments, lengths of the extension segments may increase in the second direction, and the increase of the lengths of the extension segments may be an increase by a same length each time or an increase by different lengths each time.

In the present embodiment, the symmetrical elements which are continuously folded into a square wave shape along the substrate, and the semicircular ring radiation, the feed port, and the short-circuit stub which are connected to each other may be used as a radiator. The radiator exhibits symmetrical structural characteristic based on the symmetry axis.

In the present embodiment, the feed port 142 serves as a feed point, the feed port is rectangular, and the antenna is fed by a coaxial feeding manner. The feed structure 140 is connected to the semicircular ring structure 8. In the present embodiment, there are two dipole antenna arms responsible for antenna resonance, impedance matching and performance optimization. An electrical length required for antenna resonance is compressed by a folded symmetrical element structure in a square wave shape. The short-circuit stub serves as a main matching structure to form a closed circulation current and gather energy. By adjusting folded lengths of element arms and spacing between elements, currents in a vertical direction are cancelled out, and the gathered energy is radiated along a gap between two elements, thus improving gain. In the present embodiment, a reflective ground GND is loaded at a distance of about one-quarter wavelength from the feed end of the folded dipole antenna. Since the reflective ground and the folded dipole antenna are spaced by one-quarter wavelength, radiation energy generated by the reflective ground and the dipole folded antenna in the far field is superimposed with each other and is enhanced, so that the gain of the antenna can be increased. For a dipole antenna, its radiation pattern is omnidirectional radiation. However, after the GND is added, the GND plays a reflective role, reflecting all the energy that should have been radiated to the GND side to the front of the antenna, so that the radiation pattern presents end-fire radiation. Therefore, loading the GND can not only change the radiation pattern of the antenna but also increase the gain by about 3 dB. In the present embodiment, folded lengths of two arms of a dipole antenna gradually decrease from the feed point to ends of folded elements. The elements are folded in a decreasing manner, so that at an end near the feed end, current intensity is relatively strong, and if other integrated components are added, it will lead to strong electromagnetic coupling. At an end far away from the feed end, lengths of the folded elements are relatively small, the current intensity becomes weak, and when other integrated components are added, the electromagnetic coupling is relatively small, making it easier to integrate.

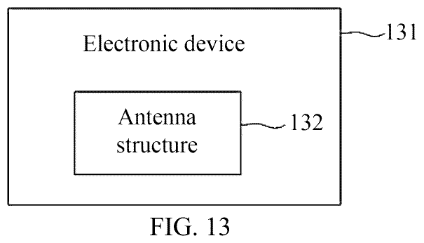

The present disclosure also provides an electronic device. As shown in FIG. 13, the electronic device 131 includes an antenna structure 132. The antenna structure 132 is an antenna structure described above.

The drawings of the present disclosure only involve structures involved in the present disclosure, and other structures may refer to conventional designs. The embodiments of the present disclosure and features in the embodiments may be combined to each other to obtain new embodiments if there is no conflict.

Those of ordinary skills in the art should understand that modifications or equivalent replacements may be made to the technical solutions of the present disclosure without departing from the essence and scope of the technical solutions of the present disclosure, and shall all fall within the scope of the claims of the present disclosure.

1. An antenna structure at least comprising a substrate, and a first element antenna arm, a second element antenna arm, a feed structure and a resonant portion that are disposed on the substrate, wherein:
the first element antenna arm is communicated with the feed structure through the resonant portion, the second element antenna arm is communicated with the feed structure through the resonant portion, and the resonant portion is communicated with the feed structure, and
the antenna structure has a symmetry axis, the first element antenna arm and the second element antenna arm are symmetrical about the symmetry axis, the resonant portion is symmetrical about the symmetry axis, and a connection point at which the resonant portion and the feed structure are connected is located on the symmetry axis.

2. The antenna structure of claim 1, wherein each one of the first element antenna arm and the second element antenna arm comprises N first extension segments extending along a first direction and N−1 second extension segments extending along a second direction, the N first extension segments are sequentially arranged in the second direction, a first end of a first first extension segment is connected to the resonant portion, and a second end of an i-th first extension segment is connected to a first end of an (i+1)-th first extension segment through a second extension segment, where i is an integer greater than 0 and less than N, and N is an integer greater than 1, and the first direction intersects with the second direction.

3. The antenna structure of claim 2, wherein a length of a first extension segment is greater than a length of the second extension segment.

4. The antenna structure of claim 3, wherein,
in each element antenna arm, lengths of a second first extension segment to an N-th first extension segment are same, and a length of the first first extension segment is smaller than the length of the second first extension segment.

5. The antenna structure of claim 3, wherein in each element antenna arm, a length of a (2j)-th first extension segment is same as a length of a (2j+1)-th first extension segment, and a length of a (2×(j+1))-th first extension segment is greater than the length of the (2j+1)-th first extension segment, where j is an integer greater than 0.

6. The antenna structure of claim 3, wherein,
in each element antenna arm, a length of a (2j)-th first extension segment is same as a length of a (2j+1)-th first extension segment, and a length of a (2×(j+1))-th first extension segment is smaller than the length of the (2j+1)-th first extension segment, where j is an integer greater than 0.

7. The antenna structure of claim 5, wherein in each element antenna arm, differences between the length of the (2×(j+1))-th first extension segment and the length of the (2j+1)-th first extension segment are same.

8. The antenna structure of claim 5, wherein in each element antenna arm, differences between the length of the (2×(j+1))-th first extension segment and the length of the (2j+1)-th first extension segment are not same.

9. The antenna structure of claim 5, wherein,
lengths of the N−1 second extension segments of each element antenna arm are same.

10. The antenna structure of claim 1, wherein:
the resonant portion comprises at least a semicircular structure, and the semicircular structure comprises a first arc-shaped edge and a linear edge,
a circle center of the semicircular structure is on the symmetry axis, the feed structure is connected to the first arc-shaped edge, and the semicircular structure has a groove at the linear edge, and
the groove is symmetrical about the symmetry axis.

11. The antenna structure of claim 1, wherein:
the resonant portion comprises at least a semicircular ring structure, the semicircular ring structure comprises a second arc-shaped edge and a third arc-shaped edge, and the second arc-shaped edge is located on a side of the third arc-shaped edge away from the first element antenna arm and the second element antenna arm, and
a circle center of the semicircular ring structure is on the symmetry axis, and the feed structure is located between the second arc-shaped edge and the third arc-shaped edge.

12. The antenna structure of claim 11, wherein:
the resonant portion further comprises a short-circuit stub, and the short-circuit stub is symmetrical about the symmetry axis,
the short-circuit stub comprises one third extension segment extending along a first direction and two fourth extension segments extending along a second direction, and the two fourth extension segments are connected by the third extension segment, and
each fourth extension segment is connected to the third arc-shaped edge, and the first direction intersects with the second direction.

13. The antenna structure of claim 12, wherein:
the resonant portion further comprises an open-circuit stub which is symmetrical about the symmetry axis, and
the open-circuit stub is connected to the second arc-shaped edge, and the open-circuit stub is located on a side of the short-circuit stub close to the second arc-shaped edge.

14. The antenna structure of claim 13, wherein,
the open-circuit stub is located on the symmetry axis.

15. The antenna structure of claim 10, wherein,
the feed structure comprises a first ground plate, a second ground plate and a microstrip line, the microstrip line is connected to the first arc-shaped edge, and the first ground plate and the second ground plate are located on two sides of the microstrip line.

16. The antenna structure of claim 15, wherein,
the microstrip line is symmetrical about the symmetry axis and is located on the symmetry axis.

17. The antenna structure of claim 10, wherein,
the feed structure comprises a coaxial cable and a feed port, and the coaxial cable is connected to the feed port.

18. The antenna structure of claim 1, wherein,
the antenna structure further comprises a reflective ground, and the reflective ground is located on a side of the feed structure away from the resonant portion.

19. The antenna structure of claim 17, wherein,
an orthographic projection of the feed port on the substrate is rectangular.

20. An electronic device, comprising the antenna structure according to claim 1.
